(19) United States
(12) Patent Application Publication
(10) Pub. No.: US 2012/0069088 A1
(43) Pub. Date: Mar. 22, 2012

(54) LIQUID DISCHARGING APPARATUS

(76) Inventors: Toshiyasu Morimoto, Kanagawa (JP); Hitoshi Kamoda, Kanagawa (JP)

(21) Appl. No.: 13/231,571

(22) Filed: Sep. 13, 2011

(30) Foreign Application Priority Data
Sep. 17, 2010 (JP) P2010-210150

(51) Int. Cl. B41J 2/165

(52) U.S. Cl. 347/32

(57) ABSTRACT

A liquid discharging apparatus includes: a liquid discharging head having liquid discharging faces; a cleaner unit having a cleaner that is separated from or brought into contact with the liquid discharging faces; a platen that is disposed to face the liquid discharging faces and retains the recording sheet; a unit driving mechanism that moves the cleaner unit along the liquid discharging faces; and a platen driving mechanism that moves the platen in a direction away from or toward the liquid discharging faces, wherein a movement pathway of the cleaner unit is formed between the liquid discharging head and the platen by moving the platen in a direction away from the liquid discharging faces, and when the cleaner unit has been located between the liquid discharging head and the platen, the cleaner is separated from or brought into contact with the liquid discharging faces by movement of the platen.

### BACKGROUND

The present disclosure relates to a technical field of a liquid discharging apparatus. Specifically, the present disclosure relates to a technical field of attaining a reduction in size and a reduction in production costs by making a cleaner be able to be moved in a direction in which the cleaner is separated from or brought into contact with liquid discharging faces of a liquid discharging head, by movement of a platen.

A liquid discharging apparatus such as an ink jet printer is provided with a platen which retains a recording sheet that is transported and a liquid discharging head which discharges liquid such as ink onto the recording sheet retained on the platen, thereby performing recording.

As for such a liquid discharging apparatus, a so-called serial head type liquid discharging apparatus, in which a liquid discharging head moves in a direction (a main scanning direction) perpendicular to the transport direction (a sub-scanning direction) of the recording sheet, thereby performing recording, and a so-called line head type liquid discharging apparatus, in which recording is performed only in the transport direction of the recording sheet by using a fixed liquid discharging head having a length covering the full width of the recording sheet, are present.

In the serial head type liquid discharging apparatus, in order to perform recording with respect to the full width of the recording sheet, it is necessary to move a head carriage (a moving body) with the liquid discharging head mounted thereon up to an area further to the outer side than each of both end portions in the width direction of the recording sheet. Therefore, a summed width of the width of the recording sheet and a width of about two times the width of the head carriage is necessary for the width of the serial head type liquid discharging apparatus. Especially, if many types of ink are used in order to increase color reproducibility, the number of liquid discharging heads that are mounted increases by a corresponding amount, whereby the head carriage further increases in size, so that the width of the liquid discharging apparatus becomes larger.

On the other hand, in the case of the line head type liquid discharging apparatus, since the width of the liquid discharging head is approximately the same as the width of the recording sheet and the liquid discharging head does not move in the main scanning direction, a necessary width is approximately equal to the width of the recording sheet. Therefore, in general, in the line head type liquid discharging apparatus, a reduction in size in the width direction becomes possible compared to the serial head type liquid discharging apparatus.

In the liquid discharging apparatuses as described above, since an image or the like is formed on the recording sheet by discharging liquid (ink) from a plurality of liquid discharging nozzles arranged at the liquid discharging head, there is concern that dust, paper dust, or the like may be attached to a liquid discharging face in which each nozzle orifice of the liquid discharging head is arranged or ink stagnation may occur. If such attachment of dust, paper dust, or the like or ink stagnation occurs, the liquid discharging face dries, so that clogging occurs in the liquid discharging nozzle, whereby discharge of liquid is inhibited, so that a discharge defect such as non-discharge or incomplete discharge is generated, leading to lowering of image quality.

Therefore, in the liquid discharging apparatuses, in order to prevent lowering of image quality and maintain the performance of the liquid discharging head, cleaning is performed which wipes away and removes contamination attached to the liquid discharging face, ink stagnation, thickened or solidified ink, or the like by moving a cleaner in a state where the cleaner is brought into contact with the liquid discharging face.

In the case of the serial head type liquid discharging apparatus, it is preferable if cleaning on the liquid discharging face is performed at the outside in the width direction of the recording sheet or at the standby position of the head carriage, and it is possible to dispose a cleaner unit having a cleaner in a space that already exists, so that a further increase in the width of the liquid discharging apparatus due to disposition of the cleaner unit is less.

On the other hand, in the case of the line head type liquid discharging apparatus, since the liquid discharging head is fixed, when cleaning is not performed, the cleaner unit is disposed in a space other than a transport pathway of the recording sheet, and when performing cleaning, it is necessary to move the cleaner unit in a state where the cleaner is brought into contact with the liquid discharging face. Therefore, it is necessary to dispose the cleaner unit in a space outside in the width direction of the recording sheet when cleaning is not performed.

In the liquid discharging apparatuses, as the distance between the liquid discharging face and the recording sheet, a range of about 0.5 mm to about 2.0 mm is appropriate and usually, a range of about 10 mm to 100 mm is necessary for the height of the cleaner unit. Therefore, in order to perform cleaning of the liquid discharging face in the line head type liquid discharging apparatus, it is necessary to provide a distance-variable mechanism which can change the distance between the liquid discharging head and the platen which retains the recording sheet.

As the liquid discharging apparatus having the distance-variable mechanism, there is a liquid discharging apparatus in which a maintenance block provided with a platen, a cleaner unit, and a unit driving mechanism that moves the cleaner unit along the liquid discharging face is made to be able to be moved in a direction away from or toward the liquid discharging face (refer to the specification of Japanese Patent Application No. 2009-299271, for example).

In the liquid discharging apparatus described in the specification of Japanese Patent Application No. 2009-299271, at the time of recording on the recording sheet, the maintenance block is moved in a direction in which it approaches the liquid discharging face, by the distance-variable mechanism, so that the distance between the liquid discharging face and the platen is set to be an appropriate distance for recording. Further, at the time of cleaning, the maintenance block is moved in a direction in which it is separated from the liquid discharging face, by the distance-variable mechanism, so that the cleaner of the cleaner unit is held at a position where it can come into contact with the liquid discharging face.

If the maintenance block is moved in a direction in which it is separated from the liquid discharging face, so that the cleaner is held at a position where it can come into contact with the liquid discharging face, the cleaner unit is moved along the liquid discharging face by a cleaner movement mechanism, so that the cleaner is moved in a contacted state with the liquid discharging face, thereby performing cleaning.

### SUMMARY

However, in the liquid discharging apparatus described in the specification of Japanese Patent Application No. 2009-299271, since the cleaner unit and the unit driving mechanism, which are not necessary to be moved at the time of recording on the recording sheet, are also moved along with the platen, it is necessary to secure movement spaces for the cleaner unit and the unit driving mechanism at the inside of the liquid discharging apparatus.

Accordingly, a space for the inside of the liquid discharging apparatus becomes large, and especially, as described above, since the cleaner unit is disposed in a space outside in the width direction of the recording sheet when cleaning is not performed, a movement space in the space outside in the width direction of the recording sheet becomes large, so that there is a problem of inhibiting a reduction in the size of the liquid discharging apparatus.

Therefore, there is a method in which a platen driving mechanism which moves the platen in a direction away from or toward the liquid discharging face and a dedicated elevating/lowering mechanism which moves the cleaner unit in a direction away from or toward the liquid discharging face are separately provided and the platen and the cleaner unit are separately moved by each mechanism, as necessary.

However, if a separate elevating/lowering mechanism from the platen driving mechanism is provided, it is necessary to provide a disposition space for the elevating/lowering mechanism, so that there is a problem of not only disturbing a reduction in size, but also increasing the number of parts of the liquid discharging apparatus, causing an increase in production costs.

Therefore, it is desirable to attain a reduction in size and a reduction in production costs.

According to an embodiment of the present disclosure, there is provided a liquid discharging apparatus including: a liquid discharging head in which a plurality of liquid discharging nozzles that discharges liquid onto a recording sheet on the basis of image information is arranged and which has liquid discharging faces in which each nozzle orifice of the plurality of liquid discharging nozzles is arranged; a cleaner unit having a cleaner that is made to be able to be moved in a direction in which the cleaner is separated from or brought into contact with the liquid discharging faces and that comes into contact with the liquid discharging faces, thereby cleaning the liquid discharging faces; a platen that is disposed to face the liquid discharging faces of the liquid discharging head and retains the recording sheet in a state where the recording sheet faces the liquid discharging faces; a unit driving mechanism that moves the cleaner unit along the liquid discharging faces; and a platen driving mechanism that moves the platen in a direction away from or toward the liquid discharging faces, wherein a movement pathway of the cleaner unit at the time of cleaning is formed between the liquid discharging head and the platen by moving the platen in a direction away from the liquid discharging faces by the platen driving mechanism, and when the cleaner unit has been located between the liquid discharging head and the platen, the cleaner is made to be separated from or brought into contact with the liquid discharging faces by movement of the platen by the platen driving mechanism.

Therefore, in the liquid discharging apparatus according to the embodiment, when the cleaner has been located between the liquid discharging head and the platen, the platen is moved by the platen driving mechanism and also the cleaner is moved in a direction in which the cleaner is separated from or brought into contact with the liquid discharging faces.

In the above liquid discharging apparatus according to the embodiment of the present disclosure, it is desirable that the cleaner unit be moved back and forth in the movement pathway by the unit driving mechanism and that the cleaner be separated from the liquid discharging faces in one of the forward path and the backward path of the movement pathway and come into contact with the liquid discharging faces in the other of the forward path and the backward path of the movement pathway, thereby performing cleaning.

By making the cleaner be separated from the liquid discharging faces in one of the forward path and the backward path and come into contact with the liquid discharging faces in the other of the forward path and the backward path, thereby performing cleaning, ink attached to the cleaner in the forward path or the backward path is not attached to the liquid discharging faces in the backward path or the forward path.

In the above liquid discharging apparatus according to the embodiment of the present disclosure, it is desirable that a capping section which opens and closes the liquid discharging faces of the liquid discharging head be provided, the cleaner be separated from the liquid discharging faces in the forward path of the movement pathway and come into contact with the liquid discharging faces in the backward path of the movement pathway, thereby performing cleaning, and the liquid discharging faces be blocked by the capping section in a state where cleaning by the cleaner on the liquid discharging faces has been performed.

By making the cleaner be separated from the liquid discharging faces in the forward path and come into contact with the liquid discharging faces in the backward path, thereby performing cleaning, the time from the end of the cleaning operation on the liquid discharging faces to capping for preventing drying of the liquid discharging nozzles is shortened.

In the above liquid discharging apparatus according to the embodiment of the present disclosure, it is desirable that the cleaner unit include a support base, a first arm which is supported on the support base so as to be able to turn and retains the cleaner, a second arm which is supported on the support base so as to be able to turn, and a biasing spring which biases the first arm in a turning direction in which the cleaner approaches the liquid discharging faces, the first arm and the second arm be made to be able to turn in the same direction with respect to the support base, the first arm be provided with an interlocking lever which is located on the opposite side to the cleaner across a turning fulcrum, the second arm be provided with an actuating lever which acts on the interlocking lever and a pushed portion which is located on the opposite side to the actuating lever across a turning fulcrum and pushed against the platen, and when the platen is moved in a direction in which the platen approaches the liquid discharging faces, the pushed portion be pushed by the platen, so that the second arm is turned and the first arm is turned in a direction of separating the cleaner from the liquid discharging faces, against the biasing force of the biasing spring by action of the actuating lever on the interlocking lever, and when the platen is moved in a direction in which the platen is separated from the liquid discharging faces, pushing against the pushed portion by the platen be released, so that the second arm is turned and the first arm is turned in a direction of making the cleaner approach the liquid discharging faces, by the biasing force of the biasing spring.

By configuring the liquid discharging apparatus as described above, the first arm and the second arm are turned in conjunction with each other and also the cleaner approaches the liquid discharging faces by the biasing force of the biasing spring.

In the above liquid discharging apparatus according to the embodiment of the present disclosure, it is desirable that a roller which is rotatable in the same direction as the turning direction of the second arm be used as the pushed portion of the second arm.

By using the roller which is rotatable in the same direction as the turning direction of the second arm as the pushed portion of the second arm, when the cleaner unit is moved in a state where the pushed portion and the platen come into contact with each other, the pushed portion is rotated with respect to the platen.

In the above liquid discharging apparatus according to the embodiment of the present disclosure, it is desirable that the cleaner unit be moved back and forth in the movement pathway by the unit driving mechanism, the cleaner be separated from the liquid discharging faces in one of the forward path and the backward path of the movement pathway and come into contact with the liquid discharging faces in the other of the forward path and the backward path of the movement pathway, thereby performing cleaning, and the cleaner be pressed against the liquid discharging faces by the biasing force of the biasing spring in the other of the forward path and the backward path of the movement pathway.

The cleaner is pressed against the liquid discharging faces by the biasing force of the biasing spring in the forward path or the backward path of the movement pathway, whereby cleaning is performed in a state where the cleaner has come into close contact with the liquid discharging faces.

In the above liquid discharging apparatus according to the embodiment of the present disclosure, it is desirable that the cleaner be rotatable only in one direction, a cleaner separation and contact mechanism which moves the cleaner in a direction in which the cleaner is separated from or brought into contact with the liquid discharging faces be provided, a rotation control mechanism which makes the cleaner be able to rotate in a first direction and be unable to rotate in a second direction opposite to the first direction be provided, a head frame that has guide portions with which the cleaner can come into contact and which are provided at an end portion in a movement direction of the cleaner unit and that covers and retains the liquid discharging head from the outer circumferential side be provided, and the cleaner be rotated in the first direction when the cleaner has come into contact with the guide portions at the time of movement of the cleaner unit.

The cleaner is rotated in the first direction when the cleaner has come into contact with the guide portions at the time of movement of the cleaner unit, whereby the position of the cleaner which performs cleaning is changed at each cleaning operation.

In the above liquid discharging apparatus according to the embodiment of the present disclosure, it is desirable that the cleaner unit be moved back and forth in the movement pathway by the unit driving mechanism, the cleaner be separated from the liquid discharging faces by the cleaner separation and contact mechanism at the time of movement in one of the forward path and the backward path of the cleaner unit, and the cleaner come into contact with the liquid discharging faces in a non-rotatable state by the rotation control mechanism at the time of movement in the other of the forward path and the backward path of the cleaner unit, thereby performing cleaning.

The cleaner comes into contact with the liquid discharging faces in a non-rotatable state by the rotation control mechanism at the time of movement in the forward path or the backward path of the cleaner unit, thereby performing cleaning, whereby ink of the portion of the cleaner, which is not brought into contact with the liquid discharging faces, is not attached to the liquid discharging faces.

In the above liquid discharging apparatus according to the embodiment of the present disclosure, it is desirable that the cleaner be provided with a ratchet gear and a ratchet mechanism which includes the ratchet gear and a ratchet claw that is engaged with a gear tooth of the ratchet gear be used as the rotation control mechanism.

By using the ratchet mechanism which includes the ratchet gear and the ratchet claw as the rotation control mechanism, rotation of the ratchet gear is restricted by the ratchet claw when a turning force in one direction is imparted to the ratchet gear.

In the above liquid discharging apparatus according to the embodiment of the present disclosure, it is desirable that the number of gear teeth of the ratchet gear be set to be a prime number.

By setting the number of gear teeth of the ratchet gear to be a prime number, the position of the cleaner is sequentially changed during the next cleaning operations, so that it is difficult for ink attached to the cleaner during the previous cleaning operation to be attached to the liquid discharging faces during the next cleaning operations.

The liquid discharging apparatus according to the embodiment of the present disclosure includes: a liquid discharging head in which a plurality of liquid discharging nozzles that discharges liquid onto a recording sheet on the basis of image information is arranged and which has liquid discharging faces in which each nozzle orifice of the plurality of liquid discharging nozzles is arranged; a cleaner unit having a cleaner that is made to be able to be moved in a direction in which the cleaner is separated from or brought into contact with the liquid discharging faces and that comes into contact with the liquid discharging faces, thereby cleaning the liquid discharging faces; a platen that is disposed to face the liquid discharging faces of the liquid discharging head and retains the recording sheet in a state where the recording sheet faces the liquid discharging faces; a unit driving mechanism that moves the cleaner unit along the liquid discharging faces; and a platen driving mechanism that moves the platen in a direction away from or toward the liquid discharging faces, wherein a movement pathway of the cleaner unit at the time of cleaning is formed between the liquid discharging head and the platen by moving the platen in a direction away from the liquid discharging faces by the platen driving mechanism, and when the cleaner unit-has been located between the liquid discharging head and the platen, the cleaner is made to be separated from or brought into contact with the liquid discharging faces by movement of the platen by the platen driving mechanism.

Therefore, since at the time of recording on the recording sheet, it is not necessary to move the cleaner unit and the unit driving mechanism along with the platen in a direction away from or toward the liquid discharging faces, it is not necessary to secure movement spaces for the cleaner unit and the unit driving mechanism inside the liquid discharging apparatus, so that it is possible to attain a reduction in the size of the liquid discharging apparatus by a corresponding amount.

Further, since it is not necessary to provide a dedicated elevating/lowering mechanism for moving the cleaner unit in a direction away from or toward the liquid discharging faces, it is possible to attain a reduction in the size of the liquid discharging apparatus and a reduction in production costs by a reduction in the number of parts.

According to the embodiment of the present disclosure, the cleaner unit is moved back and forth in the movement pathway by the unit driving mechanism and the cleaner is separated from the liquid discharging faces in one of the forward path and the backward path of the movement pathway and comes into contact with the liquid discharging faces in the other of the forward path and the backward path of the movement pathway, thereby performing cleaning.

Therefore, ink attached to the cleaner in the forward path or the backward path is not attached to the liquid discharging faces in the backward path or the forward path, so that it is possible to secure an excellent cleaning state with respect to the liquid discharging faces.

According to the embodiment of the present disclosure, the capping section which opens and closes the liquid discharging faces of the liquid discharging head is provided, the cleaner is separated from the liquid discharging faces in the forward path of the movement pathway and comes into contact with the liquid discharging faces in the backward path of the movement pathway, thereby performing cleaning, and the liquid discharging faces are blocked by the capping section in a state where cleaning by the cleaner on the liquid discharging faces has been performed.

Therefore, after the cleaning operation on the liquid discharging faces is finished, capping for preventing drying of the liquid discharging nozzles can be promptly performed, so that it is possible to prevent drying of the liquid discharging nozzles with a high probability.

According to the embodiment of the present disclosure, the cleaner unit includes the support base, the first arm which is supported on the support base so as to be able to turn and retains the cleaner, the second arm which is supported on the support base so as to be able to turn, and the biasing spring which biases the first arm in a turning direction in which the cleaner approaches the liquid discharging faces, the first arm and the second arm are made to be able to turn in the same direction with respect to the support base, the first arm is provided with the interlocking lever which is located on the opposite side to the cleaner across a turning fulcrum, the second arm is provided with the actuating lever which acts on the interlocking lever and the pushed portion which is located on the opposite side to the actuating lever across a turning fulcrum and pushed against the platen, and when the platen is moved in a direction in which the platen approaches the liquid discharging faces, the pushed portion is pushed by the platen, so that the second arm is turned and the first arm is turned in a direction of separating the cleaner from the liquid discharging faces, against the biasing force of the biasing spring by action of the actuating lever on the interlocking lever, and when the platen is moved in a direction in which the platen is separated from the liquid discharging faces, pushing against the pushed portion by the platen is released, so that the second arm is turned and the first arm is turned in a direction of making the cleaner approach the liquid discharging faces, by the biasing force of the biasing spring.

Therefore, it is possible to reliably perform movement of the cleaner by a simple mechanism.

According to the embodiment of the present disclosure, the roller which is rotatable in the same direction as the turning direction of the second arm is used as the pushed portion of the second arm.

Therefore, it is possible to reduce sliding resistance between the pushed portion and the platen when the cleaner unit is moved in a state where the pushed portion and the platen have come into contact with each other.

According to the embodiment of the present disclosure, the cleaner unit is moved back and forth in the movement pathway by the unit driving mechanism, the cleaner is separated from the liquid discharging faces in one of the forward path and the backward path of the movement pathway and comes into contact with the liquid discharging faces in the other of the forward path and the backward path of the movement pathway, thereby performing cleaning, and the cleaner is pressed against the liquid discharging faces by the biasing force of the biasing spring in the other of the forward path and the backward path of the movement pathway.

Therefore, since cleaning is performed in a state where the cleaner is pressed against the liquid discharging faces by the biasing force of the biasing spring, it is possible to attain improvement in cleaning performance.

According to the embodiment of the present disclosure, the cleaner is rotatable only in one direction, the cleaner separation and contact mechanism which moves the cleaner in a direction in which the cleaner is separated from or brought into contact with the liquid discharging faces is provided, the rotation control mechanism which makes the cleaner be able to rotate in a first direction and be unable to rotate in a second direction opposite to the first direction is provided, the head frame that has the guide portions with which the cleaner can come into contact and which are provided at an end portion in the movement direction of the cleaner unit and that covers and retains the liquid discharging head from the outer circumferential side is provided, and the cleaner is made to be rotated in the first direction when the cleaner has come into contact with the guide portions at the time of movement of the cleaner unit.

Therefore, the position of the cleaner which performs cleaning is changed at each cleaning operation, so that it is difficult for ink attached to the cleaner at the cleaning operation performed first to be attached to the liquid discharging faces during the next cleaning operations, whereby excellent cleaning on and after the next time can be performed.

According to the embodiment of the present disclosure, the cleaner unit is moved back and forth in the movement pathway by the unit driving mechanism, the cleaner is separated from the liquid discharging faces by the cleaner separation and contact mechanism at the time of movement in one of the forward path and the backward path of the cleaner unit, and the cleaner comes into contact with the liquid discharging faces in a non-rotatable state by the rotation control mechanism at the time of movement in the other of the forward path and the backward path of the cleaner unit, thereby performing cleaning.

Therefore, ink of the portion of the cleaner, which is not brought into contact with the liquid discharging faces, is not attached to the liquid discharging faces, so that it is possible to attain improvement in cleaning performance.

According to the embodiment of the present disclosure, the cleaner is provided with the ratchet gear and the ratchet mechanism which includes the ratchet gear and the ratchet claw that is engaged with a gear tooth of the ratchet gear is used as the rotation control mechanism.

Therefore, it is possible to reliably rotate the cleaner only in one direction by a simple configuration.

According to the embodiment of the present disclosure, the number of gear teeth of the ratchet gear is set to be a prime number.

Therefore, the position of the cleaner is sequentially changed during the next cleaning operations, so that it is difficult for ink attached to the cleaner during the previous cleaning operation to be attached to the liquid discharging faces during the next cleaning operations, whereby excellent cleaning on and after the next time can be performed.

### BRIEF DESCRIPTION OF THE DRAWINGS

FIG. 1 is a diagram illustrating a liquid discharging apparatus according to an embodiment of the present disclosure along with FIGS. 2 to 30 and a schematic side view of the liquid discharging apparatus.

FIG. 2 is a schematic diagram illustrating a positional relationship between a liquid discharging block, a platen, a suction section, and a cleaner unit.

FIG. 3 is a bottom view illustrating a portion of the liquid discharging block.

FIG. 4 is a side view in partial cross-section illustrating the liquid discharging block and a cleaner.

FIG. 5 is a side view illustrating the platen and a platen driving mechanism.

FIG. 6 is a schematic perspective view of the cleaner unit.

FIG. 7 is a perspective view illustrating a cleaner holder and the cleaner.

FIG. 8 is a side view illustrating the cleaner unit and a unit driving mechanism.

FIG. 9 is a cross-sectional view of the cleaner unit.

FIG. 10 is a diagram illustrating the turning states of a first arm and a second arm along with FIGS. 11 and 12 and a cross-sectional view illustrating a state where the cleaner is at the initial position.

FIG. 11 is a cross-sectional view illustrating a state where the cleaner is at a cleaning position.

FIG. 12 is a cross-sectional view illustrating a state where the cleaner is at a retreat position.

FIG. 13 is a perspective view illustrating the cleaner and the unit driving mechanism.

FIG. 14 is a conceptual diagram illustrating an example of another shape of the cleaner.

FIG. 15 is a conceptual diagram illustrating an example of still another shape of the cleaner.

FIG. 16 is a diagram illustrating an operation of the liquid discharging apparatus along with FIGS. 17 to 30 and a cross-sectional view illustrating a state before a cleaning operation is started.

FIG. 17 is a side view illustrating the states of the cleaner unit, the platen, and the platen driving mechanism before the cleaning operation is started.

FIG. 18 is a cross-sectional view illustrating a state immediately after the cleaning operation is started, so that movement of the cleaner unit in a Y1 direction is started.

FIG. 19 is a side view illustrating a state where the cleaning operation is started, so that the platen is moved downward from an elevated position up to a lowered position.

FIG. 20 is a cross-sectional view illustrating a state where a guided surface of the cleaner holder of the cleaner unit has come into contact with a tapered surface of a head frame.

FIG. 21 is a cross-sectional view illustrating a state where the cleaner unit is further moved in the Y1 direction, so that the cleaner comes into contact with one end portion of the head frame.

FIG. 22 is a cross-sectional view illustrating a state where the cleaner is rotated and the cleaner unit is then stopped temporarily.

FIG. 23 is a cross-sectional view illustrating a state where the platen is moved upward from the lowered position up to an intermediate position, so that a roller is pushed, whereby the cleaner is separated from a liquid discharging face.

FIG. 24 is a side view illustrating a state where the platen has been moved downward from the lowered position up to the intermediate position.

FIG. 25 is a cross-sectional view illustrating a state where the cleaner unit is moved again in the Y1 direction and then temporarily stopped at a position near the other end portion of the head frame.

FIG. 26 is a cross-sectional view illustrating a state where the platen is moved downward from the intermediate position up to the lowered position, so that the cleaner comes into contact with the other end portion of the head frame.

FIG. 27 is a cross-sectional view illustrating a state where the cleaner is rotated and the cleaner unit is then stopped.

FIG. 28 is a cross-sectional view illustrating a state where the cleaner unit has been moved in a Y2 direction up to one end portion of the head frame.

FIG. 29 is a cross-sectional view illustrating a state where the cleaner unit is further moved in the Y2 direction, so that the guided surface of the cleaner holder comes into contact with the tapered surface of the head frame.

FIG. 30 is a cross-sectional view illustrating a state where the cleaner unit is further moved in the Y2 direction and then stopped at the side of the platen.

### DETAILED DESCRIPTION OF EMBODIMENTS

Hereinafter, a liquid discharging apparatus according to an embodiment of the present disclosure will be described according to the accompanying drawings. In addition, an embodiment described below is an example in which the present disclosure is applied to a liquid discharging apparatus of a so-called line head type which includes a fixed liquid discharging head having a length covering the full width of a recording sheet and performs recording only in the transport direction of the recording sheet.

Configuration of Liquid Discharging Apparatus

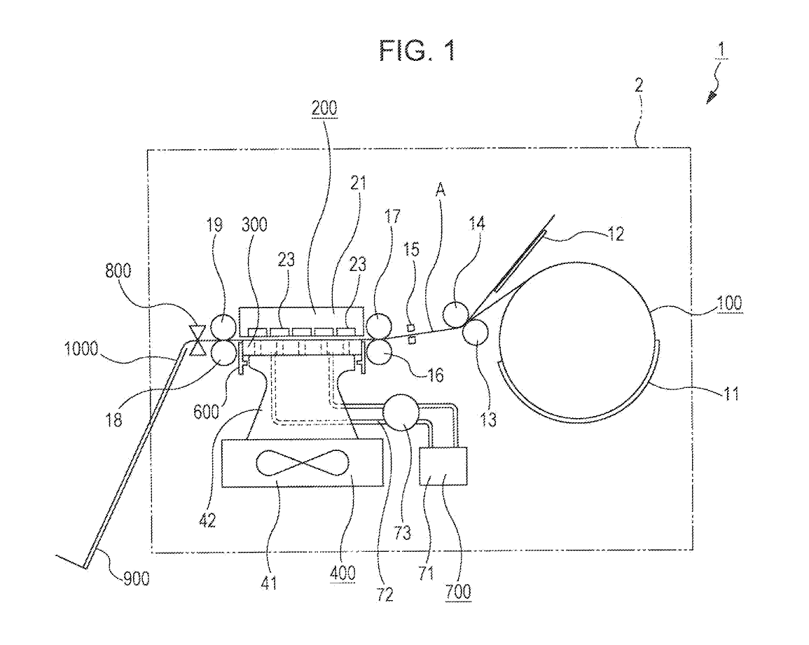

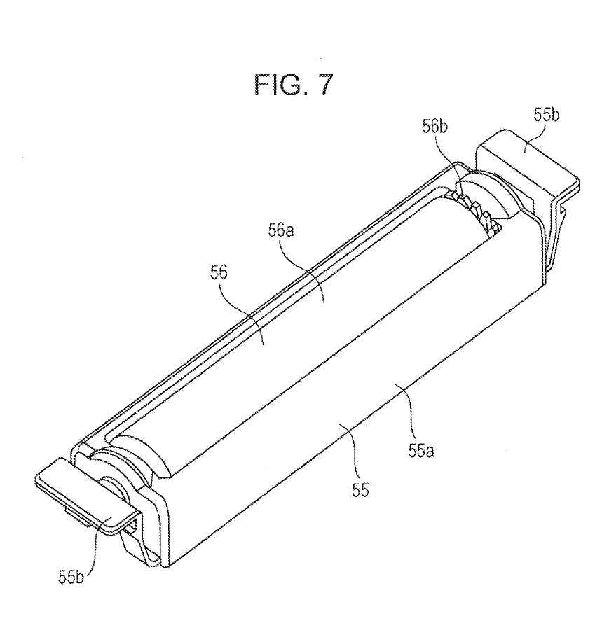

First, the configuration of the liquid discharging apparatus will be described (refer to FIGS. 1 to 15).

The necessary respective sections of a liquid discharging apparatus 1 are disposed inside and outside an outer housing 2 (refer to FIG. 1).

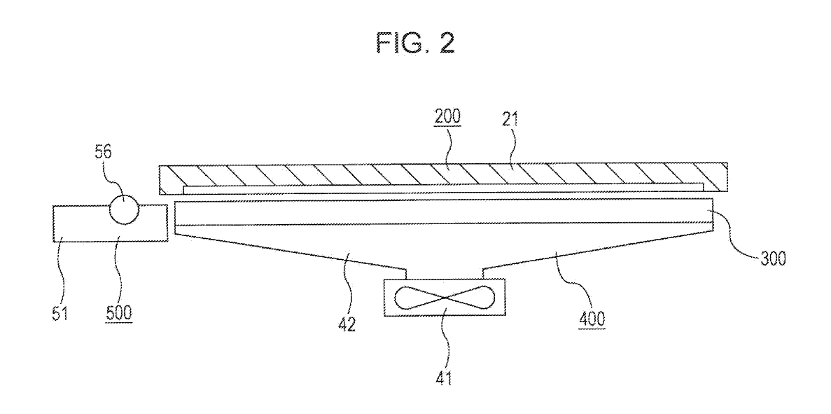

The liquid discharging apparatus 1 includes a paper feed section 100, a liquid discharging block 200, a platen 300, a suction section 400, a cleaner unit 500, a capping section 600, a moisturizer supply section 700, a cutter 800, and a paper discharge section 900, as shown in FIGS. 1 and 2.

The paper feed section 100 supplies cut paper and rolled paper which are used as a recording sheet 1000. The paper feed section 100 is provided with a rolled paper feed tray 11 in which the rolled paper as the recording sheet 1000 is loaded and a cut paper manual feed tray 12 in which the cut paper as the recording sheet 1000 is loaded.

The liquid discharging block 200 has a function of recording an image on the recording sheet 1000 which is fed and transported.

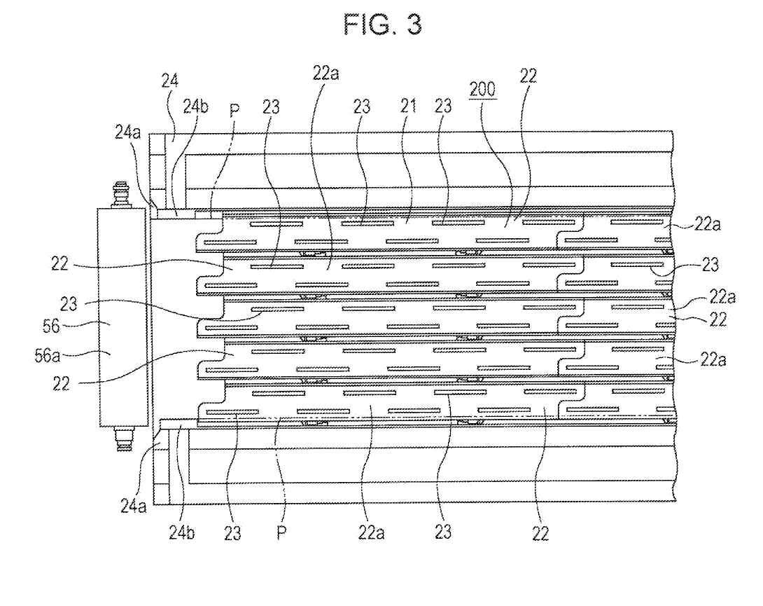

The liquid discharging block 200 has a line type liquid discharging head 21, the smaller width of which is wider than the width of the recording sheet 1000 (refer to FIG. 3).

The liquid discharging head 21 has a configuration in which module heads 22, 22, . . . which respectively discharge different liquids (inks) of, for example, five colors are disposed adjacent to each other in a sub-scanning direction (the transport direction of the recording sheet 1000).

The lower surfaces of the module heads 22, 22, . . . are respectively formed as liquid discharging faces 22a, 22a, . . . which face the upper surface of the platen 300. At each liquid discharging face 22a, a plurality of head chips 23, 23, . . . is arranged in a zigzag manner, and at each of the head chips 23, 23, . . . , a plurality of minute nozzle orifices of liquid discharging nozzles (not shown) which respectively discharge ink is arranged. Further, since it is difficult to form the nozzle orifices at both end portions in the longitudinal direction of the head chip 23, the head chips 23, 23, . . . are arranged in a zigzag manner.

The liquid discharging head 21 is provided with a plurality of electrothermal conversion elements, and the electrothermal conversion elements are selectively driven on the basis of image information, so that ink is discharged from each nozzle orifice by the pressure of film boiling generated in ink by heat generation, of the electrothermal conversion element.

The liquid discharging head 21 is retained in a state where it has been covered from the outer periphery side by a head frame 24 formed into a frame shape, and fixed to the head frame 24. Tapered surfaces 24a and 24a are formed at the lower surface side of one end portion in a main scanning direction (a direction perpendicular to the transport direction of the recording sheet 1000) of the head frame 24. The tapered surfaces 24a and 24a are formed being spaced in the sub-scanning direction from each other and are inclined so as to be displaced upward as they go outward.

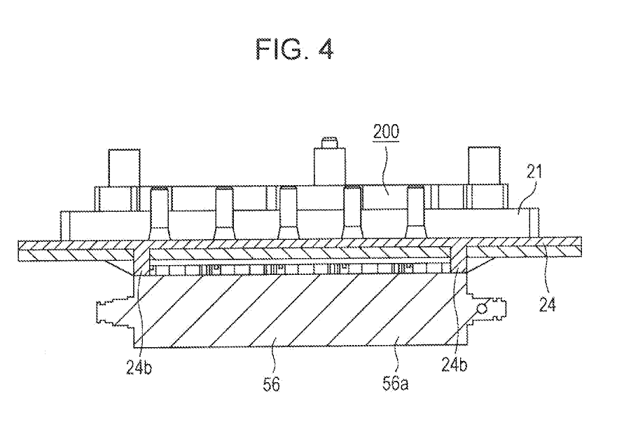

At one end portion and the other end portion of the head frame 24, guide portions 24b, 24b, . . . are formed the number of two for each end portion, and the guide portions 24b and 24b formed at one end portion are respectively continuous to the tapered surfaces 24a and 24a (refer to FIGS. 3 and 4) and the guide portions 24b and 24b formed at the other end portion of the head frame 24 are respectively located being spaced in the main scanning direction from the guide portions 24b and 24b formed at one end portion.

The guide portions 24b, 24b, . . . are located further at the outside in the sub-scanning direction than the head chips 23, 23, . . . which are located at both ends in the sub-scanning direction. That is, as shown in FIG. 3, line segments P and P extending in the main scanning direction at inner ends of the guide portions 24b, 24b, . . . are located further at the outside in the sub-scanning direction than the head chips 23, 23, . . . . The liquid discharging faces 22a, 22a, . . . are located slightly below the lower surfaces of the guide portions 24b, 24b, . . . .

Between the paper feed section 100 and the liquid discharging block 200, a paper feed roller 13, a paper feed pinch roller 14, an edge sensor 15, a transport roller 16, and a pinch roller 17 are disposed in order from the paper feed section 100 side, as shown in FIG. 1. The paper feed roller 13 and the transport roller 16 are respectively rotated by driving motors (not shown).

An encoder (not shown) and an encoder sensor (not shown) are mounted on the transport roller 16. The transport speed of the recording sheet 1000 is detected by the encoder and the encoder sensor, and on the basis of the detected transport speed, the discharge timing of ink which is discharged from the liquid discharging head 21 is set so as to synchronize with the transport speed of the recording sheet 1000.

A transport roller 18 and a pinch roller 19 are disposed on the opposite sides to the transport roller 16 and the pinch roller 17 across the liquid discharging block 200. The transport roller 18 is rotated by a driving motor (not shown).

The platen 300 is disposed below the liquid discharging block 200 so as to face the liquid discharging block 200 and has a function of retaining the recording sheet 1000.

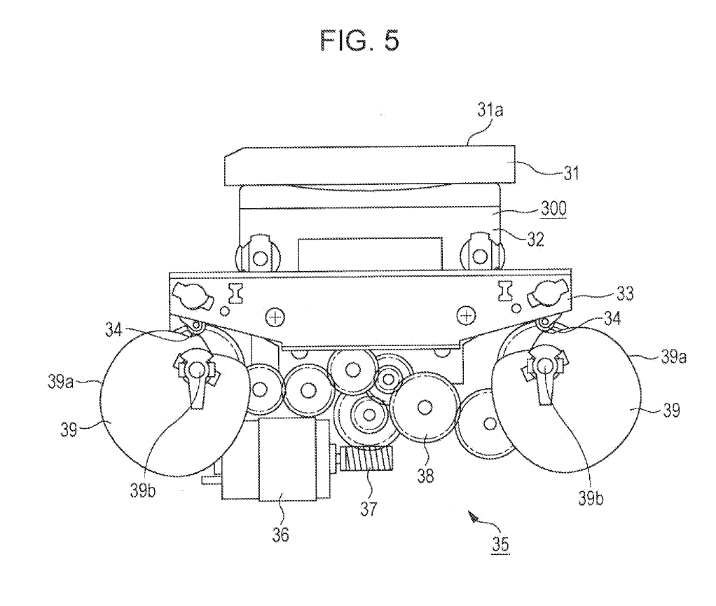

The platen 300 has a retention base 31, a connection base 32, and a cam base 33 which are combined in order from the upside (refer to FIG. 5). The upper surface of the retention base 31 is formed as a retention face 31a which retains the recording sheet 1000 which is transported. On the cam base 33, a pair of cam follower rollers 34 and 34 is supported being spaced left and right (in the sub-scanning direction) from each other.

The platen 300 is made so as to be able to be moved in a direction (up-and-down direction) away from or toward the liquid discharging faces 22a, 22a, . . . of the liquid discharging block 200 by a platen driving mechanism 35. The platen driving mechanism 35 includes a motor 36, a worm 37 fixed to a motor shaft of the motor 36, a reduction gear group 38 engaged with the worm 37, and rotating cams 39 and 39 which are respectively rotated with rotation of the reduction gear group 38.

The outer circumferential surfaces of the rotating cams 39 and 39 are respectively formed as cam faces 39a and 39a and the cam faces 39a and 39a are respectively slidably engaged with the cam follower rollers 34 and 34. Rotary shafts 39b and 39b of the rotating cams 39 and 39 are provided at eccentric positions.

In the platen driving mechanism 35, if the worm 37 is rotated with rotation of the motor 36, the reduction gear group 38 is rotated and with rotation of the reduction gear group 38, the rotating cams 39 and 39 are synchronously rotated in the opposite directions with the rotary shafts 39b and 39b as fulcrums. If the rotating cams 39 and 39 are synchronously rotated, the engagement positions of the cam follower rollers 34 and 34 with the cam faces 39a and 39a of the rotating cams 39 and 39 are changed, so that the platen 300 is moved in the up-and-down direction.

In the liquid discharging apparatus 1, the platen 300 is made so as to be able to be stopped at three different positions by the platen driving mechanism 35. As the three different positions, an elevated position where the platen 300 is located at an upper movement end at the time of non-cleaning in which cleaning by the cleaner unit 500 is not performed, an intermediate position where the platen 300 is located slightly above a lower movement end at the time of a cleaning operation by the cleaner unit 500, and a lowered position where the platen 300 is located at the lower movement end at the time of the cleaning operation by the cleaner unit 500 are set.

In the platen driving mechanism 35, the rotational positions of the rotary shafts 39b and 39b of the rotating cams 39 and 39 are detected by rotational position detection sensors (not shown) and an operation of the motor 36 is controlled in accordance with the detection results of the rotational positions.

The suction section 400 has a function of generating suction power for suctioning and sticking the recording sheet 1000 to the platen 300. The suction section 400 includes a suction fan 41 and an air suction path 42.

If the suction fan 41 is rotated, air is suctioned from the platen 300 through the air suction path 42, so that the recording sheet 1000 is suctioned and stuck to the platen 300, thereby being retained on the retention face 31a. At this time, the recording sheet 1000 is suctioned and stuck to the retention face 31a of the platen 300 by suction power which does not hinder transport.

The suction section 400 is moved in the up-and-down direction integrally with the platen 300.

The cleaner unit 500 is disposed on the side of the platen 300 and has a function of cleaning the liquid discharging faces 22a, 22a, . . . of the liquid discharging block 200.

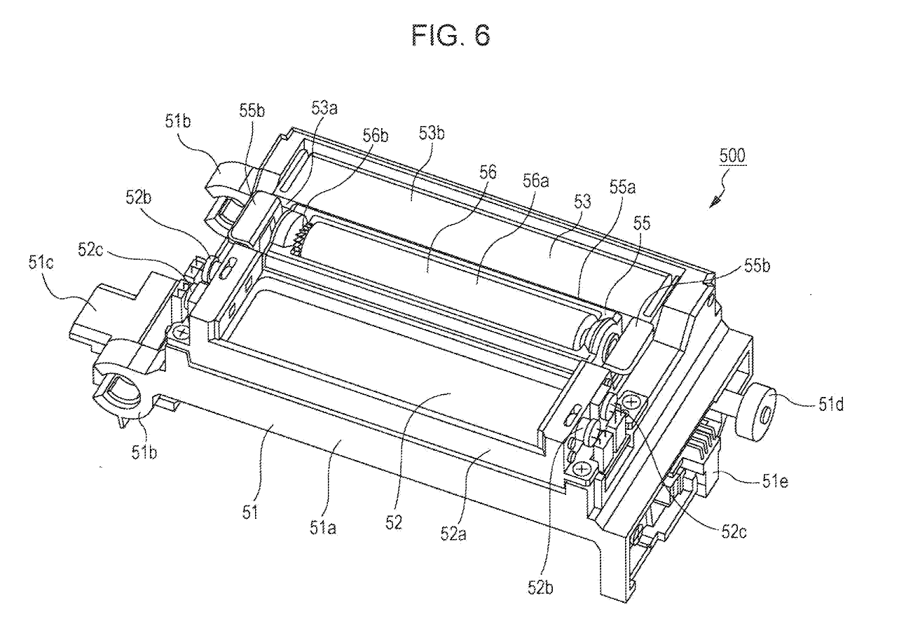

The necessary respective sections of the cleaner unit 500 are disposed on a support base 51 (refer to FIGS. 6 to 9).

The support base 51 has a support portion 51a and slide bearings 51b and 51b provided at one end portion in the sub-scanning direction of the support portion 51a, and the slide bearings 51b and 51b are located being spaced in the main scanning direction from each other. On the support base 51, a belt support section 51c protruding outward is mounted below the slide bearing 51b. A slide roller 51d is rotatably supported on the other end portion in the sub-scanning direction of the support portion 51a. On the support base 51, an encoder sensor 51e is mounted at a position in the vicinity of the slide roller 51d.

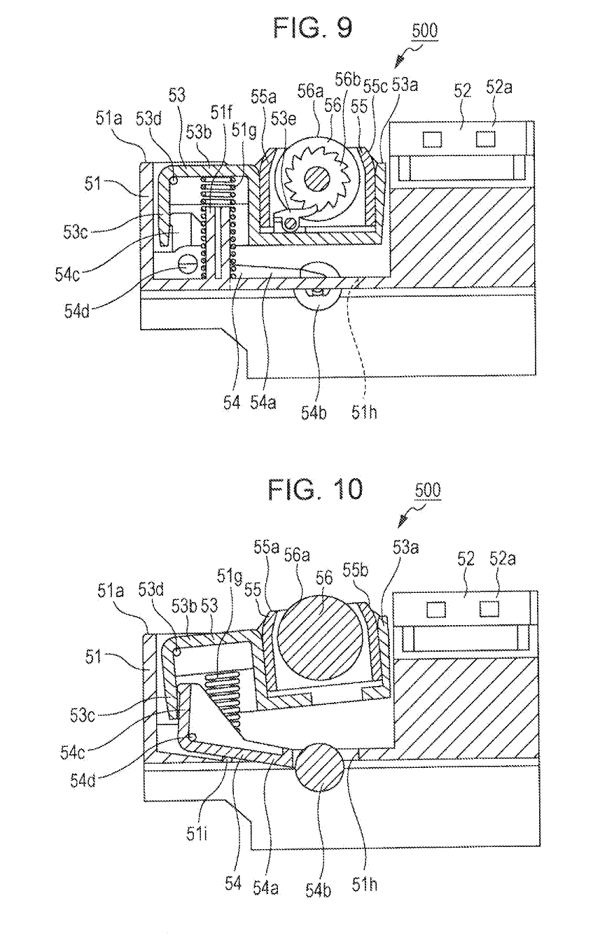

A spring support shaft portion 51f protruding upward from the support portion 51a is provided at the support base 51, as shown in FIG. 9. A biasing spring 51g that is a compression coil spring is supported on the spring support shaft portion 51f of the support base 51.

An insertion hole 51h penetrating up and down is formed in a lower end portion of the support portion 51a. In the lower end portion of the support portion 51a, a stopper portion 51i is provided at a position in the vicinity of the insertion hole 51h.

On the upper surface of the support portion 51a of the support base 51, a discharge detection section 52 is mounted, as shown in FIG. 6, and the discharge detection section 52 is disposed at one end portion in the main scanning direction, that is, an end portion on the side facing the platen 300. The discharge detection section 52 has a base for detection 52a and sensors 52b, 52b, 52c, and 52c respectively mounted on both end surfaces in the sub-scanning direction of the base for detection 52a. The sensors 52b and 52b are light emitters and the sensors 52c and 52c are light receivers. In the discharge detection section 52, discharge detection of ink is performed by detecting the amount of light incident on the sensors 52c and 52c, which is changed due to interception of a luminous flux by ink that is dropped, when light emitted from the sensors 52b and 52b is received by the sensors 52c and 52c.

On the support base 51, a first arm 53 and a second arm 54 are respectively supported on the side of the discharge detection section 52 so as to be able to turn (FIGS. 6 and 9).

The first arm 53 includes a case portion 53a opened upward, a connection portion 53b protruding laterally from an upper end portion of the case portion 53a, and an interlocking lever 53c protruding downward from the end portion of the connection portion 53b on the opposite side to the case portion 53a. The first arm 53 is made so as to be able to turn with respect to the support base 51 with a boundary portion of the connection portion 53b and the interlocking lever 53c as a turning fulcrum 53d.

In the inside of the case portion 53a of the first arm 53, a ratchet claw 53e is supported on the upper surface of a lower end portion so as to be able to turn. The ratchet claw 53e is biased in one direction in a turning direction by a torsion coil spring (not shown).

The second arm 54 includes an arm portion 54a extending approximately in a horizontal direction, rollers 54b and 54b rotatably supported on one end portion of the arm portion 54a, and an actuating lever 54c protruding upward from the other end portion of the arm portion 54a. The second arm 54 is made so as to be able to turn with respect to the support base 51 with a boundary portion of the arm portion 54a and the actuating lever 54c as a turning fulcrum 54d. The rollers 54b and 54b are located being spaced in the sub-scanning direction from each other and function as pushed portions which are pushed against the platen 300 from below.

The actuating lever 54c of the second arm 54 is slidably engaged with the interlocking lever 53c of the first arm 53. The rollers 54b and 54b of the second arm 54 at least partly protrude downward from the insertion hole 51h of the support base 51.

A cleaner holder 55 is mounted on the case portion 53a of the first arm 53 (refer to FIGS. 6, 7, and 9). The cleaner holder 55 includes a main body portion 55a formed into a box shape extending in the sub-scanning direction and opened upward and elastically deformable engagement piece portions 55b and 55b respectively protruding from both end portions in the longitudinal direction of the main body portion 55a.

A guided surface 55c is formed on the outer surface of an upper end portion of the cleaner holder 55. The guided surface 55c is inclined so as to be displaced to the inner side of the cleaner holder 55 as it goes upward.

The cleaner holder 55 is inserted into the case portion 53a and the engagement piece portions 55b and 55b are engaged with the case portion 53a, whereby cleaner holder 55 is mounted on the first arm 53. Engagement of the engagement piece portions 55b and 55b with the case portion 53a is released by elastically deforming the engagement piece portions 55b and 55b to a side close to the main body portion 55a, so that the cleaner holder 55 can be detached from the first arm 53.

In this manner, it is possible to detach the cleaner holder 55 from the first arm 53. Therefore, in a case where attachment of ink to a cleaner 56 is noticeable, so that cleaning performance is deteriorated, replacement of the cleaner holder 55 in which the cleaner 56 is supported thereon can be easily performed by a user without touching the dirty cleaner 56.

The cleaner 56 is inserted into and supported on the main body portion 55a of the cleaner holder 55. The cleaner 56 has a cleaning portion 56a formed into, for example, a cylindrical shape and a ratchet gear 56b provided at one end portion in an axial direction of the cleaning portion 56a. The cleaner 56 is supported on the main body portion 55a of the cleaner holder 55 in a state where it can rotate in a rotational direction about the axis. The number of gear teeth of the ratchet gear 56b is set to be, for example, 13 that is a prime number.

The ratchet gear 56b is engaged with the ratchet claw 53e supported on the base portion 53a of the first arm 53 so as to be able to turn. A ratchet mechanism is constituted by the ratchet claw 53e and the ratchet gear 56b and the ratchet mechanism functions as a rotation control mechanism which allows the cleaner 56 to rotate only in one direction.

In this manner, in the liquid discharging apparatus 1, since the ratchet mechanism constituted by the ratchet claw 53e and the ratchet gear 56b is used as the rotation control mechanism which allows the cleaner 56 to rotate only in one direction, it is possible to reliably rotate the cleaner 56 only in one direction by a simple configuration.

When a turning force in one direction is imparted to the cleaner 56, so that a turning force in one direction is imparted to the ratchet gear 56b; the ratchet claw 53e to which a biasing force is imparted by a torsion coil spring can be turned in the opposite direction to a direction in which the biasing force is imparted, so that rotation in one direction of the ratchet gear 56b is possible. On the contrary, when a turning force in the other direction is imparted to the cleaner 56, so that a turning force in the other direction is imparted to the ratchet gear 56b, the ratchet claw 53e to which the biasing force is imparted by the torsion coil spring is not allowed to turn in a direction in which the biasing force is imparted, so that rotation in the other direction of the ratchet gear 56b is not possible.

Therefore, the cleaner 56 is made to be able to rotate only in one direction in a rotational direction about the axis with respect to the main body portion 55a.

Further, in the above, as an example of a mechanism of restricting rotation of the cleaner 56 in one direction, the ratchet mechanism by combination of the ratchet gear 56b and the ratchet claw 53e has been illustrated. However, as the mechanism of restricting rotation of the cleaner 56 in one direction, for example, a one-way clutch mechanism may also be used.

In the cleaner unit 500 configured as described above, in a state where an external force is not imparted to the first arm 53 and the second arm 54, as shown in FIG. 10, the cleaner 56 is held at the initial position of the topmost end by the biasing force of the biasing spring 51g. At this time, in the second arm 54, the arm portion 54a is brought into contact with the stopper portion 51i by the biasing force of the biasing spring 51g transmitted from the interlocking lever 53c of the first arm 53, so that the rollers 54b and 54b are located at the lowermost end.

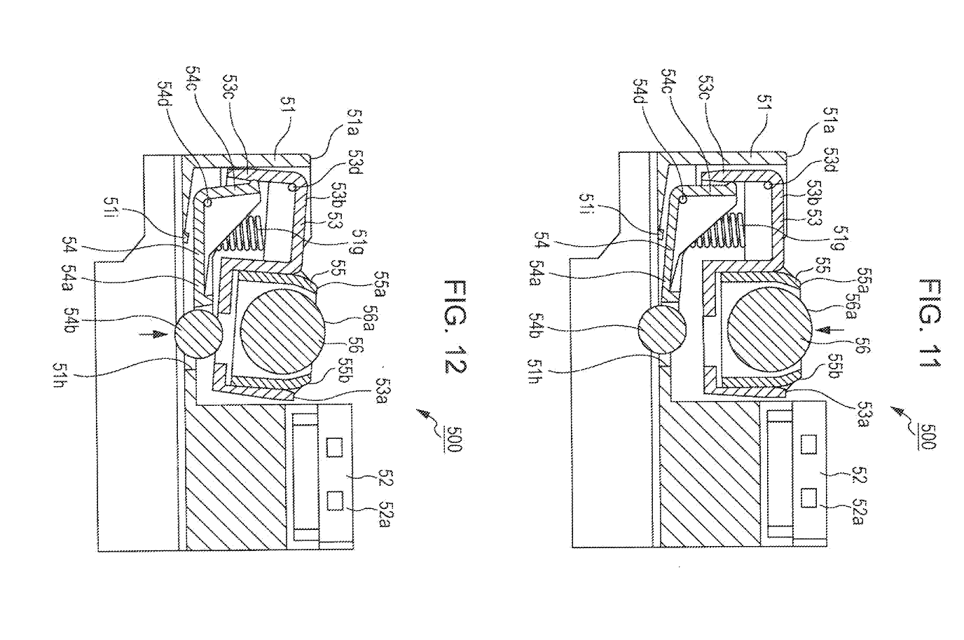

In a state where the cleaner 56 is at the initial position, if the cleaner 56 is pushed from above by the liquid discharging head 21, as shown in FIG. 11, the interlocking lever 53c and the actuating lever 54c are slid, so that the first arm 53 and the second arm 54 are turned against the biasing force of the biasing spring 51g in conjunction with each other in a direction in which the case portion 53a and the rollers 54b and 54b approach each other. The first arm 53 is turned up to a position slightly above the turning end on the lower side in a turning range and the second arm 54 is turned up to a position slightly below the turning end on the upper side in a turning range, whereby the cleaner 56 is held at a cleaning position where the cleaner 56 cleans the liquid discharging faces 22a, 22a, . . . of the liquid discharging head 21.

In a state where the cleaner 56 is at the cleaning position, if the rollers 54b and 54b of the second arm 54 are pushed from below by the platen 300, as shown in FIG. 12, the interlocking lever 53c and the actuating lever 54c are slid, so that the first arm 53 and the second arm 54 are turned against the biasing force of the biasing spring 51g in conjunction with each other in a direction in which the case portion 53a and the rollers 54b and 54b further approach each other. The first arm 53 is turned up to the turning end on the lower side in the turning range and the second arm 54 is turned up to the turning end on the upper side in the turning range, whereby the cleaner 56 is held at a retreat position where the cleaner 56 is retreated downward from the liquid discharging faces 22a, 22a, . . . of the liquid discharging head 21.

In a state where the cleaner 56 is at the retreat position, if pushing from below against the rollers 54b and 54b of the second arm 54 by the platen 300 is released, the interlocking lever 53c and the actuating lever 54c are slid, so that the first arm 53 and the second arm 54 are turned in conjunction with each other by the biasing force of the biasing spring 51g in a direction in which the case portion 53a and the rollers 54b and 54b are separated from each other. The first. arm 53 is turned up to the turning end on the upper side in the turning range and the second arm 54 is turned up to the turning end on the lower side in the turning range, whereby the arm portion 54a of the second arm 54 comes into contact with the stopper portion 51i, so that the cleaner 56 is held at the initial position again (refer to FIG. 10).

As described above, pushing against the rollers 54b and 54b by the platen 300 or release of the pushing is performed, so that the first arm 53 and the second arm 54 are turned in conjunction with each other, whereby the cleaner 56 is moved in a direction in which the cleaner 56 is separated from or brought into contact with the liquid discharging faces 22a, 22a, . . . . Therefore, the platen 300, the first arm 53, and the second arm 54 function as a cleaner separation and contact mechanism which moves the cleaner 56 in a direction in which the cleaner 56 is separated from or brought into contact with the liquid discharging faces 22a, 22a, . . . .

Further, in the above, an example in which the pushed portions of the second arm 54 which are pushed by the platen 300 are set to be the rotatable rollers 54b and 54b has been illustrated. However, the pushed portions of the second arm 54 are not limited to the rotatable rollers 54b and 54b and may also be pushed portions formed integrally with the second arm 54. By forming the pushed portions integrally with the second arm 54, it is possible to attain a reduction in production costs due to a reduction in the number of parts.

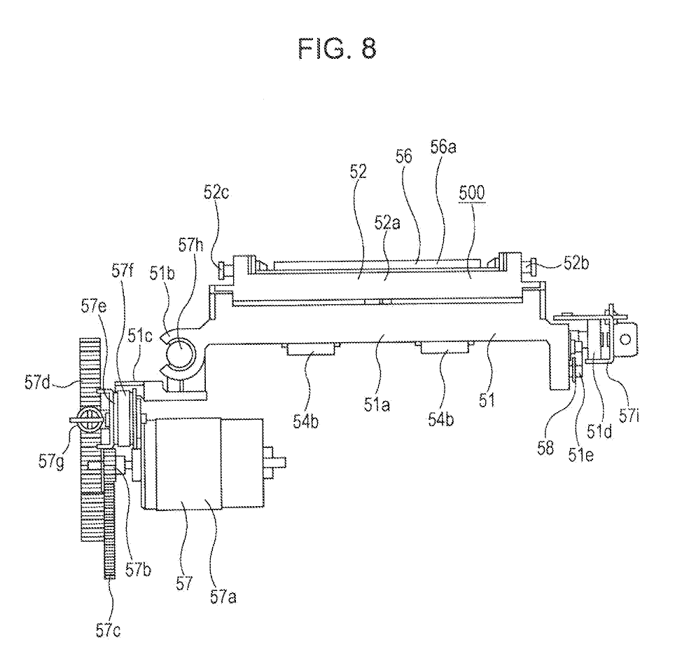

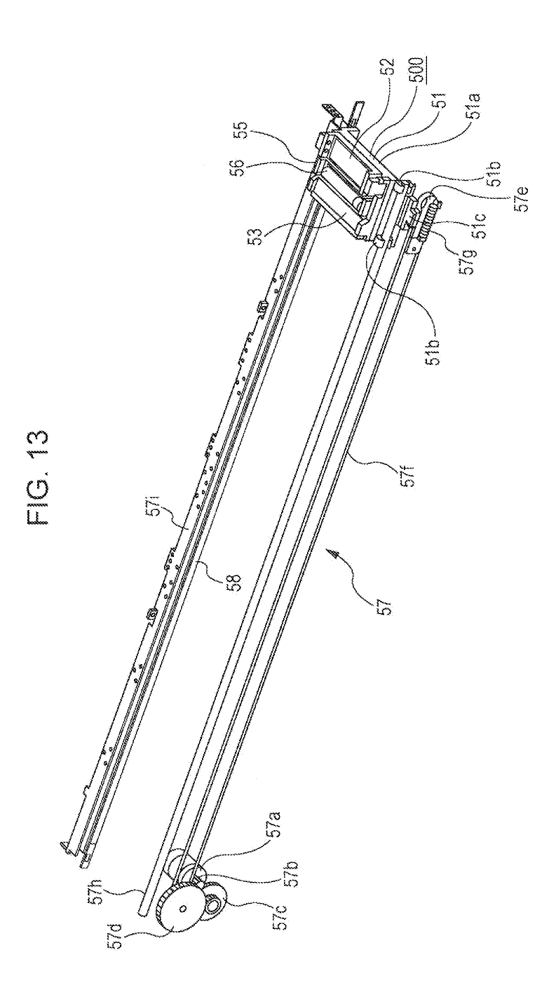

The cleaner unit 500 is made so as to be able to be moved in the main scanning direction by a unit driving mechanism 57 (refer to FIGS. 8 and 13).

The unit driving mechanism 57 includes a motor for movement 57a, a motor gear 57b, a two-stage gear 57c, a gear pulley 57d, a pulley 57e, an endless belt 57f, a tensioner 57g, a guide shaft 57h, and a guide rail 57i.

The motor gear 57b is fixed to a motor shaft of the motor for movement 57a and the motor gear 57b, the two-stage gear 57c, and the gear pulley 57d are engaged in order. The gear pulley 57d and the pulley 5′7e are located being spaced in the main scanning direction from each other and the endless belt 57f is wound between the two. Appropriate tension is imparted to the endless belt 57f by the tensioner 57g. A portion of the endless belt 57f is connected to the belt support section 51c provided at the support base 51 of the cleaner unit 500.

The guide shaft 57h and the guide rail 57i are disposed in a state where they extend in the main scanning direction along the endless belt 57f in a parallel state.

An encoder 58 extending in the main scanning direction along the guide rail 57i is disposed in the vicinity of the guide rail 57i.

In the cleaner unit 500, each of the guide bearings 51b and 51b is slidably supported on the guide shaft 57h, the slide roller 51d is rotatably engaged with the guide rail 57i, and the encoder sensor 51e is slidably engaged with the encoder 58.

In the unit driving mechanism 57, if the motor for movement 57a is rotated, the motor gear 57b, the two-stage gear 57c, and the gear pulley 57d are rotated, so that the endless belt 57f wound between the gear pulley 57d and the pulley 57e is driven in a direction according to the rotational direction of the motor for movement 57a. Therefore, the cleaner unit 500 is moved in the main scanning direction in accordance with the rotational direction of the motor for movement 57a while being guided by the guide shaft 57h and the guide rail 57i.

At this time, the encoder 58 is read by the encoder sensor 51e, the timing of a discharge operation of ink from each nozzle orifice formed in the head chips 23, 23, . . . of the liquid discharging head 21 is set in accordance with the position of the discharge detection section 52 in the main scanning direction, and discharge information about all the liquid discharging nozzles of the liquid discharging head 21 is detected.

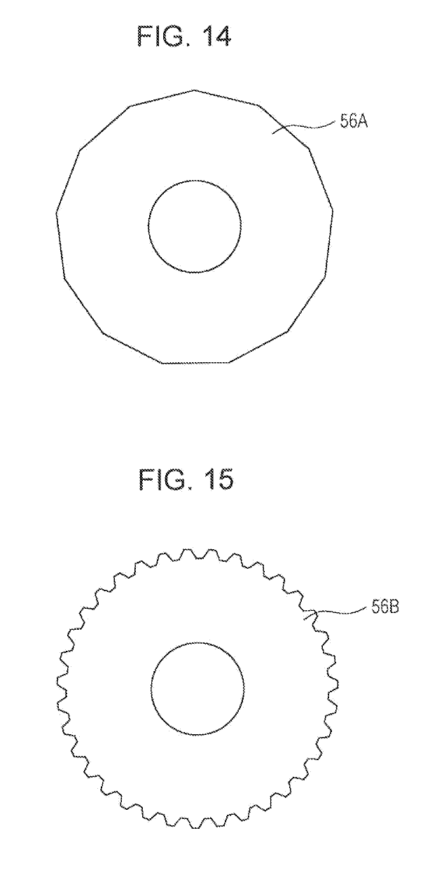

Further, in the above, an example in which the cleaning portion 56a of the cleaner 56 is formed into a cylindrical shape has been illustrated. However, for example, a cleaner 56A (refer to FIG. 14) having a cross-sectional shape of a polygonal shape may also be used instead of the cleaner 56 and a cleaner 56B (refer to FIG. 15) having an outer circumferential portion formed into a concavo-convex shape may also be used instead of the cleaner 56.

The capping section 600 has a function of improving the hermetic sealing properties of a space which is formed between the liquid discharging faces 22a, 22a, . . . of the liquid discharging block 200 and the platen 300, thereby preventing drying or the like of ink which is discharged from the liquid discharging block 200.

The moisturizer supply section 700 has a function of supplying moisturizer in order to make the space between the liquid discharging faces 22a, 22a, . . . of the liquid discharging block 200 and the platen 300 hermetically sealed by the capping section 600 be in a wet state.

The moisturizer supply section 700 includes a moisturizer storage section 71 in which the moisturizer is stored, a moisturizer supply tube 72 which becomes a moisturizer supply path from the moisturizer storage section 71 up to the platen 300, and a moisturizer supply pump 73 disposed at an intermediate portion of the moisturizer supply tube 72.

The moisturizer stored in the moisturizer storage section 71 is sent from the moisturizer supply tube 72 to an absorber (not shown) provided inside the platen 300 by the driving of the moisturizer supply pump 73, so that the space between the liquid discharging faces 22a, 22a, . . . and the platen 300 is made to be in a wet state.

The cutter 800 has a function of cutting the rolled paper as the recording sheet 1000 and the paper discharge section 900 is a section to which the recording sheet 1000 with an image recorded thereon by the liquid discharging block 200 is discharged.

Transport Operation of Recording Sheet in Liquid Discharging Apparatus

Next, an operation from paper feed up to paper discharge of the recording sheet 1000 in the liquid discharging apparatus 1 will be described (refer to FIG. 1).

The recording sheet 1000 is transported in a transport path A from the paper feed section 100 up to the paper discharge section 900.

The rolled paper or the cut paper is fed from the rolled paper feed tray 11 with the rolled paper as the recording sheet 1000 loaded therein or the cut paper manual feed tray 12 with the cut paper as the recording sheet 1000 loaded therein by the paper feed roller 13 and the paper feed pinch roller 14.

The recording sheet 1000 that is transported is detected by the edge sensor 15 and further transported toward between the liquid discharging block 200 and the platen 300 by the transport roller 16 and the pinch roller 17.

When the recording sheet 1000 is transported by the transport roller 16 and the pinch roller 17, the capping section 600 is operated, so that the transport path A between the liquid discharging block 200 and the platen 300 is opened, and the suction fan 41 of the suction section 400 is rotated. The recording sheet 1000 is suctioned to and retained on the retention face 31a of the platen 300 by the suction power of the suction section 400.

If a total transport amount of a transport amount by the paper feed roller 13 from the point of time when the edge sensor 15 has detected the leading end of the recording sheet 1000 and a transport amount by the transport roller 16 reaches a predetermined value, a recording operation on the recording sheet 1000 by the liquid discharging block 200 is started.

If the recording sheet 1000 passes the transport roller 16 and the pinch roller 17, the recording sheet 1000 is further transported toward the paper discharge section 900 by the transport roller 18 which is rotated in synchronization with the transport roller 16, and the pinch roller 19.

If recording on the recording sheet 1000 is finished, the operation of the suction fan 41 is stopped and the recording sheet 1000 is transported up to the paper discharge section 900. In the case of the cut paper, the recording sheet 1000 is transported up to the paper discharge section 900 without an operation of the cutter 800, and in the case of the rolled paper, the recording sheet 1000 is cut by the cutter 800 and then transported up to the paper discharge section 900.

If the transport operation of the recording sheet 1000 is finished, the capping section 600 is operated again, so that the space between the liquid discharging block 200 and the platen 300 is blocked and hermetically sealed.

Cleaning Operation in Liquid Discharging Apparatus

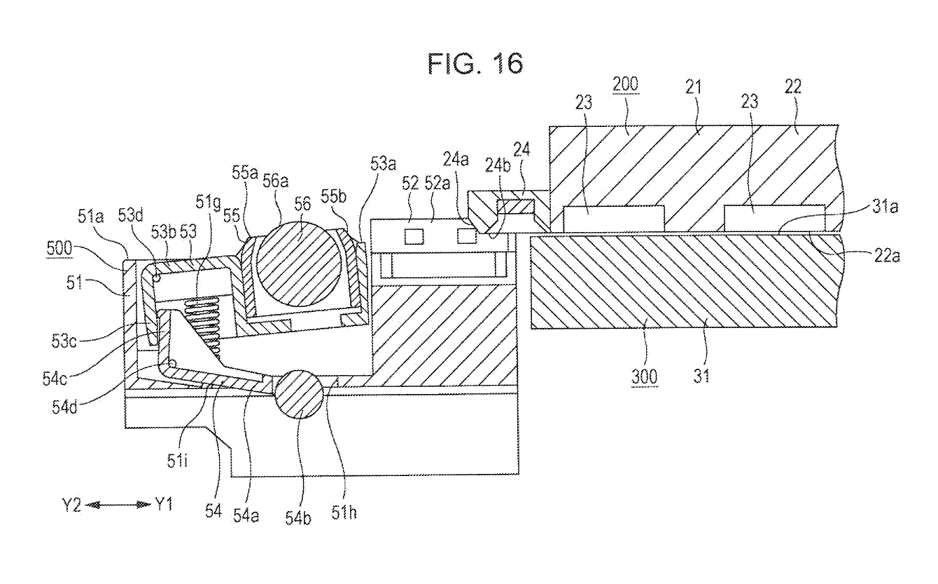

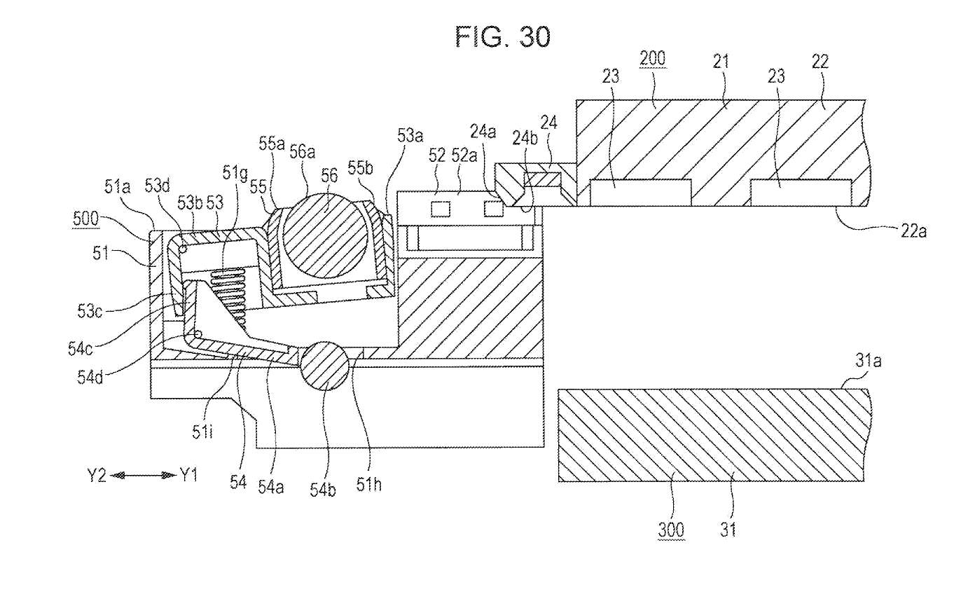

Next, the cleaning operation on the liquid discharging faces 22a, 22a, . . . by the cleaner unit 500 in the liquid discharging apparatus 1 will be described (refer to FIGS. 16 to 30).

For example, in a case where ink is not discharged from the liquid discharging nozzles of the liquid discharging block 200 without performing the recording operation for a long period of time, ink attached to the vicinity of the nozzle orifices of the liquid discharging faces 22a, 22a, . . . by the previous recording operation sometimes evaporates and dries, thereby being thickened or solidified, and there is a case where difficulty in normal ink discharge from the liquid discharging nozzles is created. Further, also in a case where the recording operation is performed frequently, paper dust or dust is sometimes attached to the liquid discharging faces 22a, 22a, . . . or discharge of ink from the liquid discharging nozzles is sometimes hindered by the remaining ink by the previous recording operation, causing poor discharge.

Therefore, at the time of power-on of the liquid discharging apparatus 1 or for every certain amount of recording, by moving the cleaner 56 in a state where the cleaner 56 is brought into contact with the liquid discharging faces 22a, 22a, . . . , the liquid discharging faces 22a, 2,2a, . . . are cleaned as follows.

In the cleaning operation described below, the cleaner unit 500 reciprocates between both end portions of the liquid discharging block 200. However, the contact of the cleaner 56 with the liquid discharging faces 22a, 22a, . . . is performed only in one of the forward path and the backward path. At this time, the cleaner 56 is rotated by a predetermined amount and in the cleaning operations on and after the second time, a configuration is made such that cleaning is performed by a portion different from the portion of the cleaner 56 which has previously come into contact with the liquid discharging faces 22a, 22a, . . . .

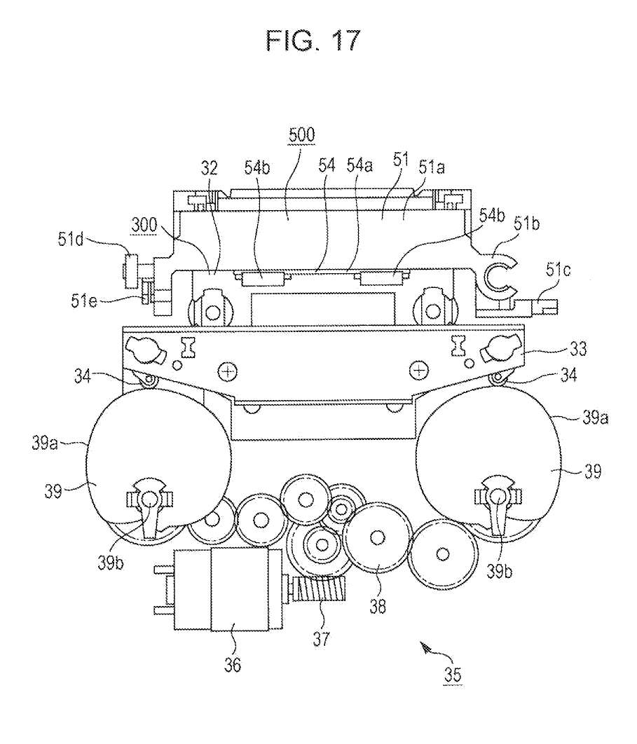

In the initial state (refer to FIG. 16) before the cleaning operation is performed, the platen 300 is at the elevated position (refer to FIG. 17) and the retention face 31a of the retention base 31 of the platen 300 is located close to the liquid discharging faces 22a, 22a, . . . of the liquid discharging head 21 of the liquid discharging block 200. The initial state is a state of the time of standby of the liquid discharging apparatus 1, the time of recording, the time of transport of the recording sheet 1000, or the like.

The cleaner unit 500 is located on the side of the platen 300 and the cleaner 56 is at the initial position. Therefore, the first arm 53 is turned up to the turning end on the upper side in the turning range and the second arm 54 is turned up to the turning end on the lower side in the turning range.

If the liquid discharging apparatus 1 is powered on or the number of recorded sheets with respect to the recording sheet 1000, becomes the predetermined number of sheets, instructions of intent to start the cleaning operation are issued, so that the cleaning operation is started.

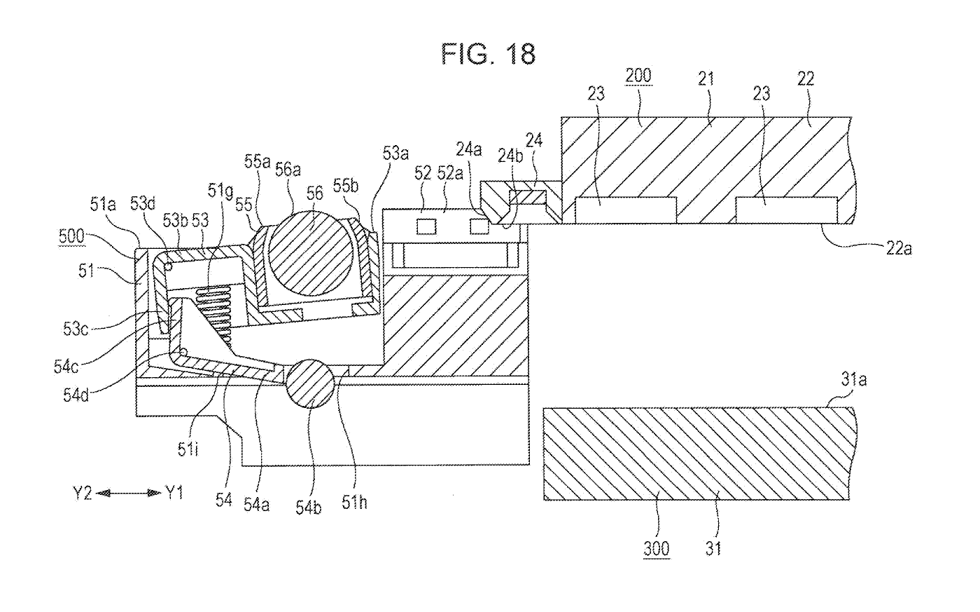

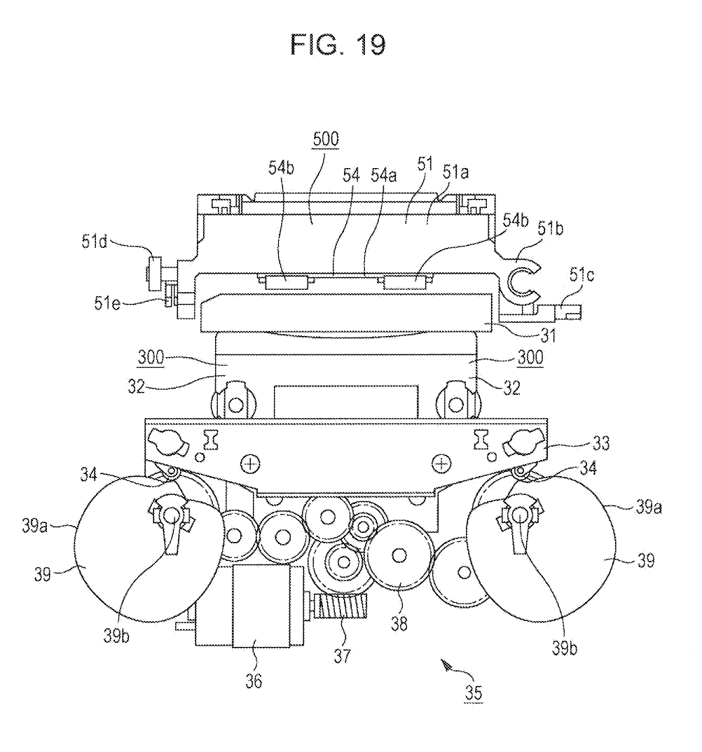

If the cleaning operation is started, the platen 300 is moved up to the lowered position by the platen driving mechanism 35 (FIGS. 18 and 19). At this time, the suction section 400 is also moved downward integrally with the platen 300. The platen 300 is moved up to the lowered position by the platen driving mechanism 35, whereby a movement pathway of the cleaner unit 500 is formed between the platen 300 and the liquid discharging block 200.

In a state where the platen 300 has been moved to the lowered position, when the cleaner unit 500 has been moved in the main scanning direction and located between the liquid discharging block 200 and the platen 300, as will be. described later, the platen 300 is held at a position where the retention face 31a does not come into contact with the rollers 54b and 54b of the cleaner unit 500.

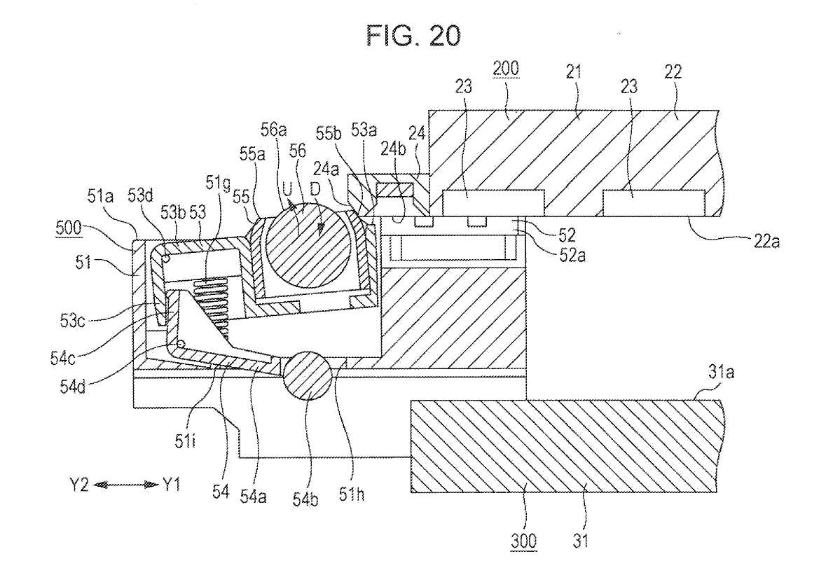

Next, a movement operation in the forward path is started, so that the cleaner unit 500 is moved in a Y1 direction in the main scanning direction (the Y1 direction or a Y2 direction) by the unit driving mechanism 57, whereby the cleaner unit 500 is inserted between the liquid discharging block 200 and the platen 300 from one end portion side toward the other end portion side of the liquid discharging block 200 (refer to FIG. 20).

If the cleaner unit 500 is moved in the Y1 direction, the guided surface 55c of the cleaner holder 55 of the cleaner unit 500 comes into contact with the tapered surfaces 24a and 24a of the head frame 24. If the cleaner unit 500 is further moved in the Y1 direction, the first arm 53 is turned in a D direction shown in FIG. 20 around the turning fulcrum 53d while the guided surface 55c is guided by the tapered surfaces 24a and 24a. At this time, although a biasing force in a U direction shown in FIG. 20 is imparted to the first arm 53 by the biasing spring 51g, the first arm 53 is turned in the D direction against the biasing force.

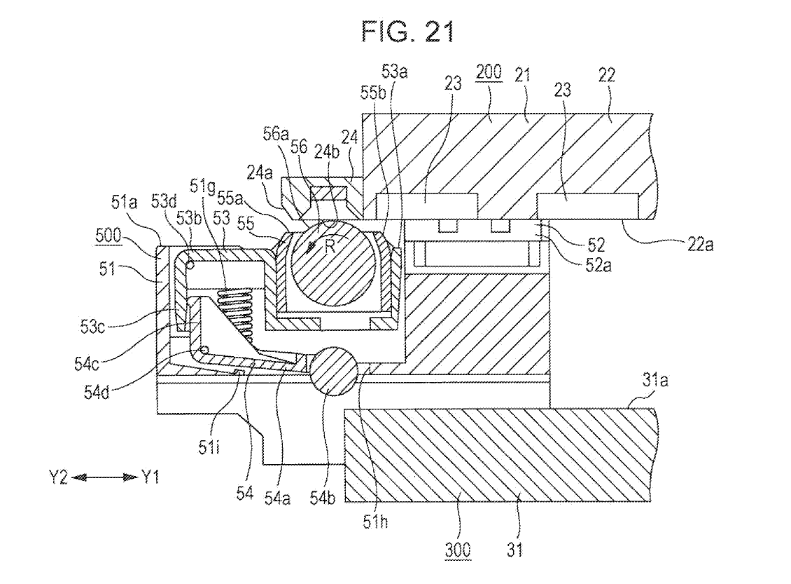

If the cleaner unit 500 is further moved in the. Y1 direction, the cleaner 56 comes into contact with the tapered surfaces 24a and 24a and subsequently, as shown in FIG. 21, both end portions in the axial direction of the cleaning portion 56a of the cleaner 56 respectively come into contact with the guide portions 24b and 24b of the head frame 24. At this time, the cleaner unit 500 is turned by an interlocking operation of the first arm 53 and the second arm 54, so that the cleaner 56 is held at the cleaning position. At the cleaning position, the cleaner 56 is pressed against the guide portions 24b and 24b by the biasing force of the biasing spring 51g.

Since the cleaner 56 can be rotated only in one direction (a R1 direction shown in FIG. 21) by the ratchet mechanism, as described above, the cleaner 56 is rotated in the R1 direction by movement of the cleaner unit 500 in the Y1 direction in a state where the cleaner 56 has come into contact with the guide portions 24b and 24b.

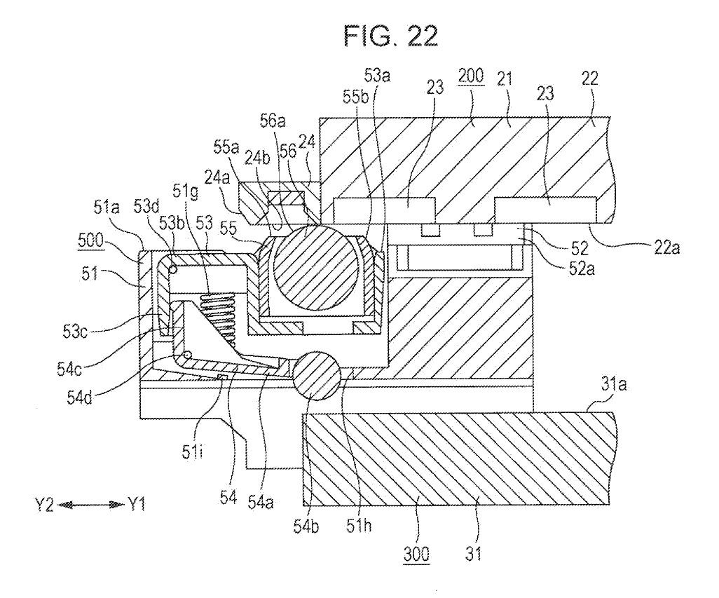

The movement of the cleaner unit 500 in the Y1 direction is temporarily stopped at a position just before the liquid discharging faces 22a, 22a, . . . (refer to FIG. 22). At this time, the rollers 54b and 54b of the second arm 54 of the cleaner unit 500 are located being spaced upward from the retention face 31a of the platen 300.

During the period, from a state where the cleaner 56 has come into contact with the tapered surfaces 24a and 24a of the head frame 24 to the time when the cleaner unit 500 is temporarily stopped at a position just before the liquid discharging faces 22a, 22a, . . . , the cleaner 56 is being rotated in the R1 direction.

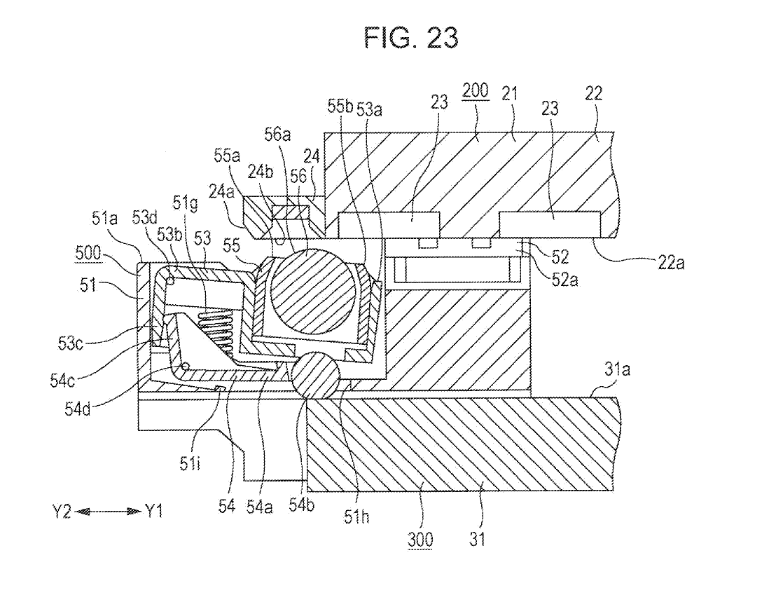

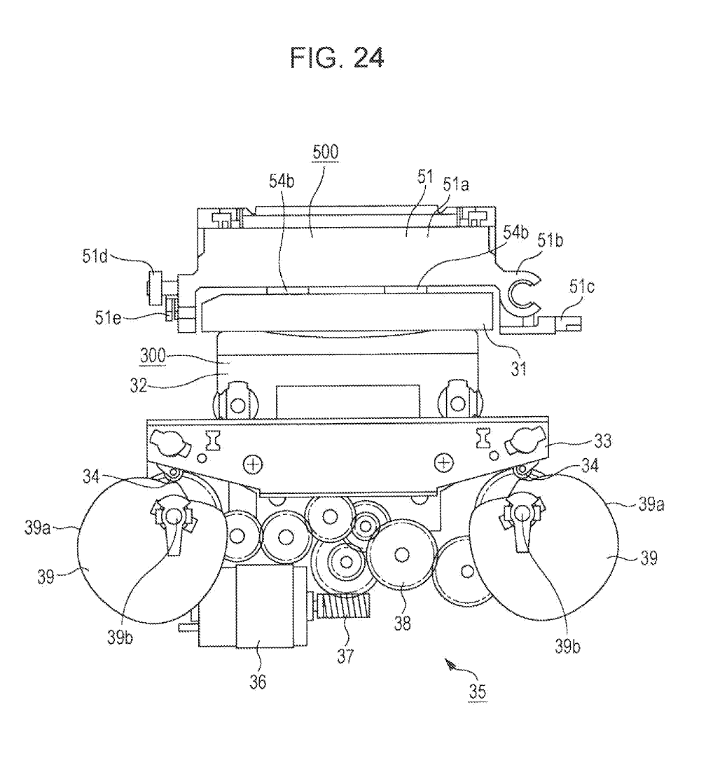

Next, the platen 300 is moved upward up to the intermediate position by the platen driving mechanism 35 (refer to FIGS. 23 and 24). If the platen 300 is moved upward, the rollers 54b and 54b of the cleaner unit 500 are pushed from below by the retention face 31a, so that the second arm 54 and the first arm 53 are turned in conjunction with each other, whereby the cleaner 56 is separated downward from the liquid discharging block 200 and held at the retreat position.

If the first arm 53 is turned, so that the cleaner 56 is separated downward from the liquid discharging block 200, movement of the platen 300 is stopped.

Further, by using the rotatable rollers 54b and 54b as the pushed portions which are pushed by the platen 300, it is possible to reduce sliding resistance between the pushed portions and the retention face 31a of the platen 300 when the cleaner unit 500 is moved in the main scanning direction in a state where the pushed portions and the retention face 31a of the platen 300 has come into contact with each other.

Further, by using the rotatable rollers 54b and 54b as the pushed portions, it is possible to reduce abrasion of the retention face 31a of the platen 300 and the pushed portions.

Next, in a state where the rollers 54b and 54b are pushed from below by the retention face 31a and the cleaner 56 is held at the retreat position, movement of the cleaner unit 500 in the Y1 direction is resumed.

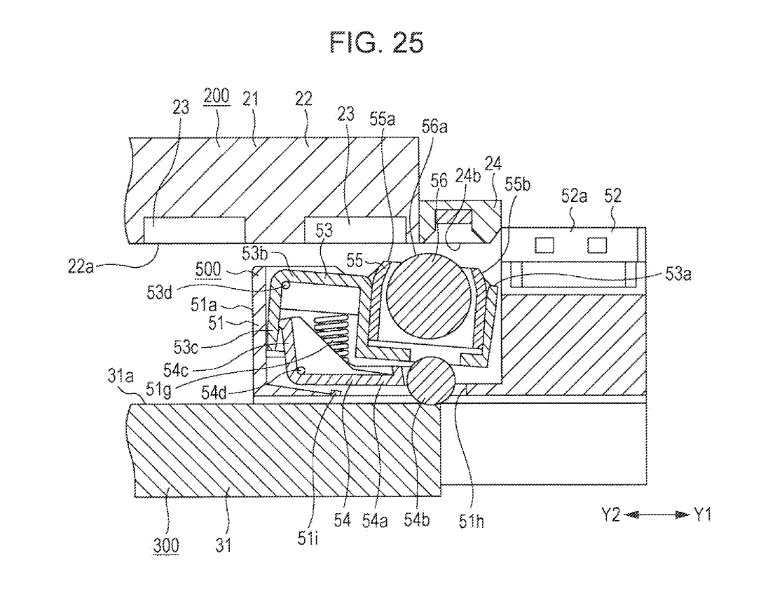

The cleaner unit 500 is moved up to a position near the other end portion of the liquid discharging block 200 by the unit driving mechanism 57 and then stopped temporarily (refer to FIG. 25). At this time, the retention face 31a of the platen 300 comes into contact with the rollers 54b and 54b, and just above the cleaner 56, the liquid discharging faces 22a, 22a, . . . are not present, but the lower surface of the other end portion of the head frame 24 is present.

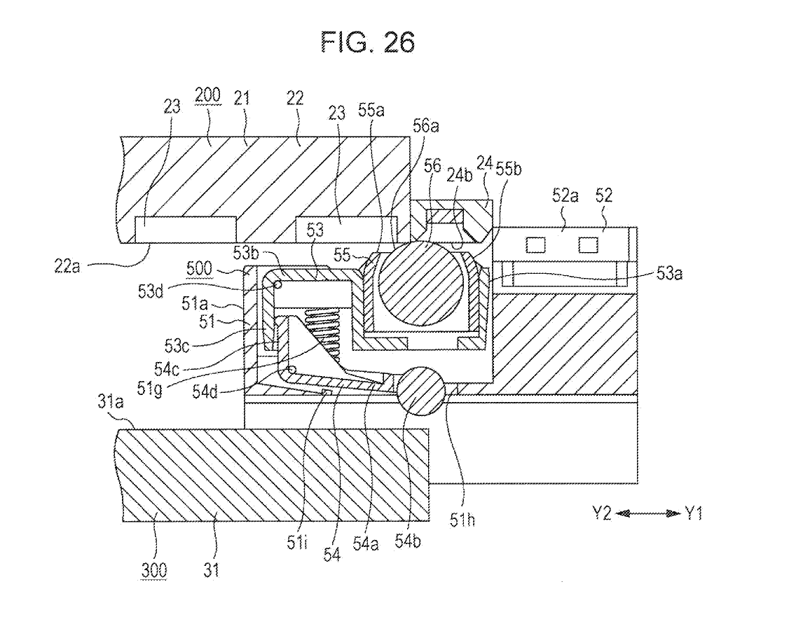

Next, the platen 300 is moved downward up to the lowered position by the platen driving mechanism 35 (refer to FIG. 26). If the platen 300 is moved downward, pushing from below against the rollers 54b and 54b by the platen 300 is released, so that the first arm 53 and the second arm 54 are turned in conjunction with each other by the biasing force of the biasing spring 51g, whereby the cleaner 56 is brought into contact with the lower surface of the head frame 24. Therefore, the cleaner 56 is held at the cleaning position.

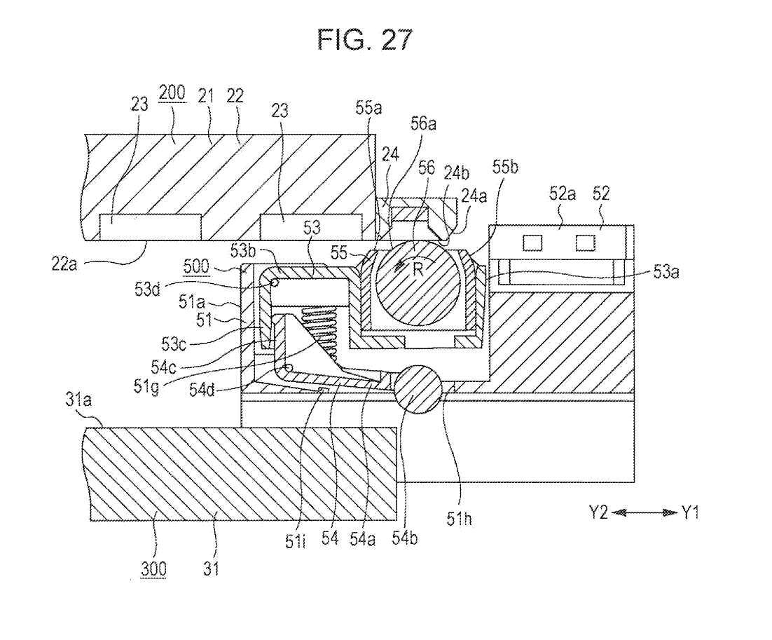

Subsequently, the cleaner unit 500 is moved again in the Y1 direction by the unit driving mechanism 57 and then stopped at a predetermined position (refer to FIG. 27). At this time, the cleaner 56 enters a state where it comes into contact with the lower surface of the other end portion of the head frame 24.

During the time since the cleaner 56 has been brought into contact with the lower surface of the head frame 24 again and until the cleaner 56 is moved in the Y1 direction and stopped in a state where it has come into contact with the lower surface of the other end portion, the cleaner 56 is being rotated in the R1 direction. Therefore, the cleaner 56 is rotated once in the R1 direction at one end portion of the head frame 24 immediately after the start of the cleaning operation and rotated again in the R1 direction at the other end portion of the head frame 24.

The cleaner unit 500 is stopped in a state where the cleaner 56 has come into contact with the lower surface of the other end portion of the liquid discharging block 200, whereby the movement operation in the forward path is finished.

If the movement operation in the forward path of the cleaner unit 500 is finished, subsequently, the movement operation in the backward path of the cleaner unit 500 is started, so that the cleaner unit 500 is moved in the Y2 direction in the main scanning direction by the unit driving mechanism 57.

When the cleaner unit 500 is moved in the Y2 direction, the cleaner unit 500 is moved in the Y2 direction in a state where the cleaner 56 is pressed against the liquid discharging faces 22a, 22a, . . . of the liquid discharging head 21 by the biasing force of the biasing spring 51g. Therefore, the liquid discharging faces 22a, 22a, . . . are cleaned by the cleaning portion 56a of the cleaner 56.

Although at this time, a turning force in the opposite direction to the R1 direction is imparted to the cleaner 56, since rotation of the cleaner 56 in the opposite direction to the R1 direction is restricted by the rotation control mechanism (the ratchet mechanism), the cleaner 56 is moved in the Y2 direction in a non-rotatable state. Further, as described above, since the lower surfaces of the liquid discharging faces 22a, 22a, . . . are located slightly below the lower surfaces of the guide portions 24b, 24b, . . . the cleaner 56 is reliably brought into contact with the liquid discharging faces 22a, 22a, . . . , so that excellent cleaning by the cleaner 56 is performed.

Further, in a state where the cleaner 56 is located at one end portion and the other end portion of the head frame 24, a state is created where only both end portions of the cleaning portion 56a of the cleaner 56 respectively come into contact with the guide portions 24b, 24b, . . . and the portion between both end portions of the cleaning portion 56a is not brought into contact with any portion of the head frame 24. Although at this time, the cleaner 56 is rotated in the R1 direction, since only both end portions of the cleaning portion 56a respectively come into contact with the guide portions 24b, 24b, . . . at the time of rotation, it is possible to prevent attachment of paper dust, dust, or the like to the area (the portion between both end portions of the cleaning portion 56a) of the cleaner 56, which cleans the liquid discharging faces 22a, 22a, . . . .

Therefore, it is possible to increase the cleaning effect and also prolong the duration of the cleaning effect of the cleaner 56.

In the liquid discharging apparatus 1, as described above, the cleaner 56 is rotated while being pressed against one end portion of the head frame 24 immediately after the start of the movement operation in the forward path of the cleaner unit 500 and also rotated while being pressed against the other end portion of the head frame 24 immediately before the end of the movement operation in the forward path of the cleaner unit 500.

However, if it is possible to secure the necessary rotational amount of the cleaner 56, the rotation of the cleaner 56 may also be made to be performed only once immediately after the start of the movement operation in the forward path of the cleaner unit 500. By making the rotation of the cleaner 56 be performed only once immediately after the start of the movement operation in the forward path of the cleaner unit 500, the movement of the cleaner unit 500 at the other end portion of the head frame 24 can be omitted, so that speed-up of the cleaning operation can be attained.

Further, in the liquid discharging apparatus 1, setting is made such that the cleaner 56 is rotated through about 180 degrees when the cleaner unit 500 moves in the forward path. In this manner, a configuration is made such that the angle of rotation of the cleaner 56 is set to be about 180° and the next cleaning operation is performed by a portion different from the portion of the cleaner 56, which has come into contact with the liquid discharging faces 22a, 22a, . . . during the previous cleaning operation. However, the angle of rotation of the cleaner 56 is not limited to about 180°.

Further, the cleaner 56 is made to be able to rotate only in one direction by the rotation control mechanism and can be stopped in a non-step manner at the time of rotation in the R1 direction. However, when a turning force in the opposite direction to the R1 direction is imparted to the cleaner 56, the cleaner 56 is fixed at any place of 13 places which are the number of the gear teeth of the ratchet gear 56b. Therefore, by increasing the number of the gear teeth of the ratchet gear 56b, it is possible to increase the places where the cleaner 56 is fixed.

However, since there is limitation on the size of the diameter of the ratchet gear 56b, if the number of the gear teeth of the ratchet gear 56b is increased, the teeth of the ratchet gear 56b and the ratchet claw 53e become small, so that there is concern that it will not become possible to obtain sufficient strength for performing fixing at the ratchet gear 56b and the ratchet claw 53e. Therefore, in order to allow the limited fixing positions of the cleaner 56 to be used more conveniently and evenly, in the liquid discharging apparatus 1, the number of the gear teeth of the ratchet gear 56b is set to be 13. However, the number of the gear teeth of the ratchet gear 56b is not limited to 13.

Further, by setting the number of the gear teeth of the ratchet gear 56b to be a prime number, when being rotated in the R1 direction, it is difficult for the position of the cleaning portion 56a of the cleaner 56 which performs cleaning at the next cleaning operation to become equal to the previous position and the position of the cleaning portion 56a is sequentially changed during the next cleaning operations. Therefore, it is difficult for ink attached to the cleaning portion 56a during the previous cleaning operation to be attached to the liquid discharging faces 22a, 22a, . . . during the next cleaning operations, so that excellent cleaning on and after the next time can be performed.

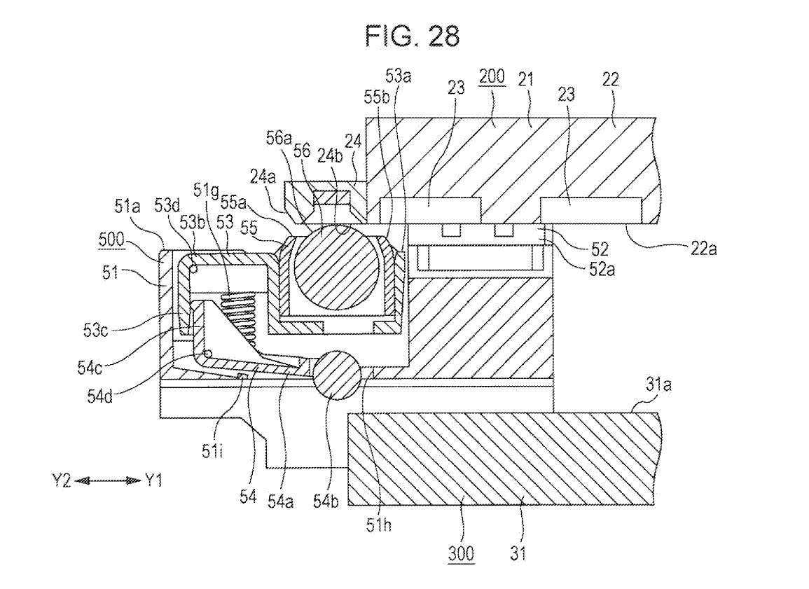

The cleaner unit 500 is moved in the Y2 direction up to one end portion of the head frame 24 (refer to FIG. 28). When the cleaner unit 500 is moved in the Y2 direction up to one end portion of the head frame 24, as described above, the cleaner 56 is brought into contact with the liquid discharging faces 22a, 22a, . . . in a non-rotatable state and cleaning on the liquid discharging faces 22a, 22a, . . . is performed.

In this manner, in the liquid discharging apparatus 1, the cleaner 56 is brought into contact with the liquid discharging faces 22a, 22a, . . . in a non-rotatable state and performs cleaning. Therefore, ink of the portion of the cleaning portion 56a, which is not brought into contact with the liquid discharging faces 22a, 22a, . . . , is not attached to the liquid discharging faces 22a, 22a, . . . , so that improvement in cleaning performance can be attained.

When performing cleaning on the liquid discharging faces 22a, 22a, . . . by the cleaner 56, the first arm 53 is biased in a direction in which the cleaner 56 moves approximately upward, by the biasing force of the biasing spring 51g. Therefore, since cleaning is performed in a state where the cleaner 56 is pressed against the liquid discharging faces 22a, 22a, . . . by the biasing force of the biasing spring 51g, improvement in cleaning performance can be attained.

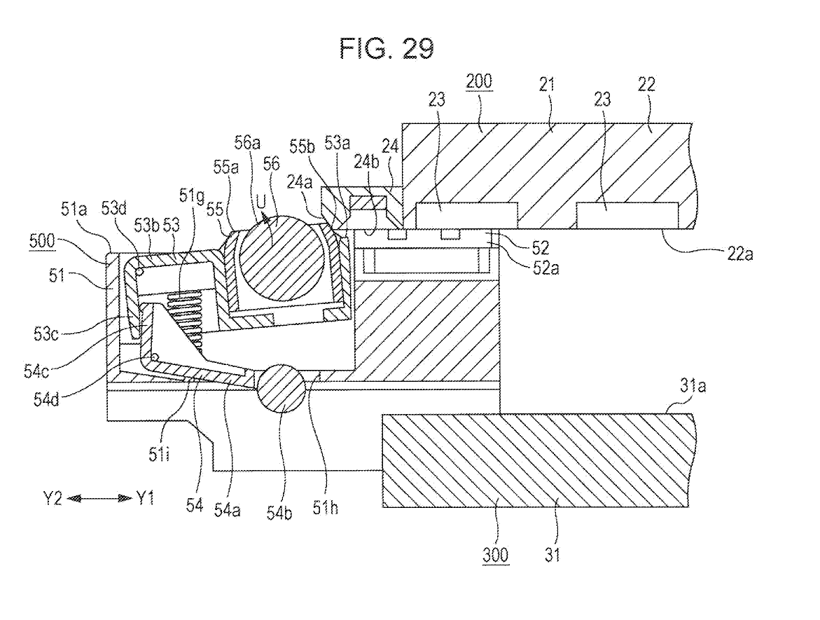

The cleaner unit 500 is continuously moved in the Y2 direction by the unit driving mechanism 57 (refer to FIG. 29). If the cleaner unit 500 is continuously moved in the Y2 direction, the guided surface 55c of the cleaner holder 55 which supports the cleaner 56 comes into contact with the tapered surfaces 24a and 24a.

If the cleaner unit 500 is further moved in the Y2 direction, the first arm 53 is turned in the U direction shown in FIG. 29 around the turning fulcrum 53d by the biasing force of the biasing spring 51g while the guided surface 55c is guided by the tapered surfaces 24a and 24a. At this time, the second arm 54 is turned in a direction in which the rollers 54b and 54b move approximately downward, in conjunction with the turning operation of the first arm 53.

If the cleaner unit 500 is further moved in the Y2 direction, the cleaner holder 55 is separated from the tapered surfaces 24a and 24a and the first arm 53 and the second arm 54 are further turned in conjunction with each other, so that cleaner 56 returns to the initial position. The cleaner unit 500 is located and stopped on the side of the platen 300.

The cleaner unit 500 is located and stopped on the side of the platen 300, whereby the movement operation in the backward path of the cleaner unit 500 is finished. The stop position of the cleaner unit 500 is a position where the cleaner unit 500 does not interfere in the platen 300 when the platen 300 is moved upward by the platen driving mechanism 35.

Finally, the platen 300 is moved upward by the platen driving mechanism 35, thereby returning to the initial state (refer to FIG. 16) before the cleaning operation is performed. In the initial state, the platen 300 is at the elevated position (refer to FIG. 17) and the retention face 31a of the retention base 31 of the platen 300 is located close to the liquid discharging faces 22a, 22a, . . . of the liquid discharging head 21 of the liquid discharging block 200. The initial state is a state of the time of standby of the liquid discharging apparatus 1, the time of recording, the time of transport of the recording sheet 1000, or the like.

The cleaner unit 500 is located on the side of the platen 300 and the cleaner 56 is at the initial position. Therefore, the first arm 53 is turned up to the turning end on the upper side in the turning range and the second arm 54 is turned up to the turning end on the lower side in the turning range.

Thereafter, in order to prevent drying of the liquid discharging nozzles arranged at the liquid discharging head 21, capping by the capping section 600 is performed, so that a space which is formed between the liquid discharging faces 22a, 22a, . . . of the liquid discharging block 200 and the platen 300 is hermetically sealed.

Effects or the like of Liquid Discharging Apparatus

As described above, in the liquid discharging apparatus 1, at the movement operation in the backward path of the cleaner unit 500, cleaning is performed in a state where the cleaner 56 is brought into contact with the liquid discharging faces 22a, 22a, . . . .

Therefore, after the cleaning operation on the liquid discharging faces 22a, 22a, . . . is finished, capping for preventing drying of the liquid discharging nozzles can be promptly performed, so that it is possible to prevent drying of the liquid discharging nozzles with a high probability.

However, it is also possible to perform cleaning on the liquid discharging faces 22a, 22a, . . . only at the movement operation in the forward path of the cleaner unit 500 or at the reciprocating operation of the cleaner unit 500.

By performing cleaning on the liquid discharging faces 22a, 22a, . . . only at the movement operation in the forward path or the movement operation in the backward path of the cleaner unit 500, ink attached to the cleaning portion 56a in the forward path or the backward path is not attached to the liquid discharging faces 22a, 22a, . . . in the backward path or the forward path. Therefore, it is possible to secure an excellent cleaning state on the liquid discharging faces 22a, 22a, . . . .

Further, in the above, a configuration is illustrated in which the distance between the platen 300 and the cleaner unit 500 is narrowed, whereby a portion (the rollers 54b and 54b) of the cleaner unit 500 is pushed by the platen 300, so that the cleaner 56 is separated from the liquid discharging faces 22a, 22a, . . . and when the distance between the platen 300 and the cleaner unit 500 is widened, so that the platen 300 is separated from the cleaner unit 500, the cleaner 56 comes into contact with the liquid discharging faces 22a, 22a, . . . .

However, in the liquid discharging apparatus 1, it is not limited to such a configuration and a configuration may also be made such that the distance between the platen 300 and the cleaner unit 500 is narrowed, whereby a portion of the cleaner unit 500 is pushed by the platen 300, so that the cleaner 56 comes into contact with the liquid discharging faces 22a, 22a, . . . and when the distance between the platen 300 and the cleaner unit 500 is widened, so that the platen 300 is separated from the cleaner unit 500, the cleaner 56 is separated from the liquid discharging faces 22a, 22a, . . . .

However, when the cleaner unit 500 is moved in the main scanning direction in a state where the platen 300 and a portion of the cleaner unit 500 have come into contact with each other, there is a possibility that the cleaner unit 500 may vibrate because a number of holes (not shown) such as suction openings or idling discharging openings are present in the surface of the platen 300. Further, since the discharge detection section 52 is provided at the cleaner unit 500, there is a possibility that false detection may occur due to vibration in detection of a discharge state of ink from the liquid discharging nozzles by the discharge detection section 52.

It is preferable that when performing the detection of a discharge state by the discharge detection section 52, the cleaner 56 come into contact with the liquid discharging faces 22a, 22a, . . . , thereby performing cleaning, and it is desirable that in a state where the cleaner 56 remains in contact with the liquid discharging faces 22a, 22a, . . . , the platen 300 and the cleaner unit 500 be separated from each other. Therefore, a configuration is desirable in which a portion of the cleaner unit 500 is pushed by the platen 300, so that the cleaner 56 is separated from the liquid discharging faces 22a, 22a, . . . and when the platen 300 has been separated from the cleaner unit 500, the cleaner 56 comes into contact with the liquid discharging faces 22a, 22a, . . . .

Further, in the liquid discharging apparatus 1, a configuration is made such that the discharge detection section 52 is provided at the cleaner unit 500, so that it is possible to detect a discharge state of the liquid discharging nozzle by moving the cleaner unit 500 in the main scanning direction. In a case where a discharge defect has been detected in the liquid discharging nozzle by the detection of the discharge state of the liquid discharging nozzle, by variably controlling a discharge direction, ink is discharged from the liquid discharge nozzle different from the liquid discharge nozzle where a discharge defect is generated, thereby correcting the effect of discharge defect, whereby it is possible to reduce a recording defect in the main scanning direction due to a discharge defect (refer to Japanese Unexamined Patent Application Publication No. 2004-181657).

Therefore, it is desirable to perform discharge detection by the discharge detection section 52 immediately after cleaning of the liquid discharging faces 22a, 22a, . . . by the cleaner 56. This is because in the case of performing discharge detection by the discharge detection section 52 before cleaning, if correction by variable control of a discharge direction is performed when the liquid discharging nozzle determined as causing a discharge defect has returned to a normal by the immediately following cleaning by the cleaner 56, it becomes over-correction.

Therefore, in the liquid discharging apparatus 1, a configuration is made such that the cleaner 56 is disposed further at the head side than the discharge detection section 52 in the Y1 direction and when the cleaner unit 500 is moved in the Y1 direction, cleaning of the liquid discharging faces 22a, 22a, . . . by the cleaner 56 is first performed and immediately following it, discharge detection by the discharge detection section 52 is performed.

Therefore, in the liquid discharging apparatus 1, over-correction by variable control of a discharge direction is not performed and optimization of correction and excellent recording quality with respect to the recording sheet 1000 can be secured.

Further, in the liquid discharging apparatus 1, at the time between the cleaning of the liquid discharging faces 22a, 22a, . . . by the cleaner 56 and the discharge detection by the discharge detection section 52, preliminary discharge may also be performed from the liquid discharging nozzle that is a detection target.

However, the width in the main scanning direction of the cleaner unit 500 significantly affects the full width of the liquid discharging apparatus 1 and the discharge detection section 52 occupies a large area with respect to the size in the main scanning direction of the cleaner unit 500. Therefore, in a case where a demand for recording quality is not so high as to demand correction when a discharge defect has been generated by the detection result of the discharge detection section 52 or a case where it is possible to prevent generation of a discharge defect by cleaning by the cleaner 56 or the like, it is also possible to attain a reduction in the size of the liquid discharging apparatus 1 by omitting the discharge detection section 52.

As described above, the liquid discharging apparatus 1 includes the liquid discharging head 21, the cleaner unit 500, the platen 300, the unit driving mechanism 57, and the platen driving mechanism 35 and is made such that the cleaner 56 is moved in a direction in which the cleaner 56 is separated from or brought into contact with the liquid discharging faces 22a, 22a, . . . , by movement of the platen 300 by the platen driving mechanism 35.

Therefore, at the time of recording on the recording sheet 1000, it is not necessary to move the cleaner unit 500 and the unit driving mechanism 57 along with the platen 300 in a direction away from or toward the liquid discharging faces 22a, 22a, . . . .

In this manner, since the cleaner unit 500 and the unit driving mechanism 57 are not in a direction away from or toward the liquid discharging faces 22a, 22a, . . . , it is not necessary to secure movement spaces for the cleaner unit 500 and the unit driving mechanism 57 inside the liquid discharging apparatus 1, so that it is possible to attain a reduction in size of the liquid discharging apparatus 1 by a corresponding amount.

Further, since it is also not necessary to provide a dedicated elevating/lowering mechanism for moving the cleaner unit 500 in a direction away from or toward the liquid discharging faces 22a, 22a, . . . , a reduction in size of the liquid discharging apparatus 1 and a reduction in production costs by a reduction in the number of parts can be attained.

Further, in the liquid discharging apparatus 1, a configuration is made such that cleaning is performed in a state where rotation of the cleaner 56 has been restricted and that by rotating the cleaner 56 before cleaning is performed, the next cleaning operation is performed at a portion different from the portion contacted with the liquid discharging faces 22a, 22a, . . . during the previous cleaning.

Therefore, the position of the cleaning portion 56a of the cleaner 56 which performs cleaning is changed at each cleaning operation, so that it is difficult for ink attached to the cleaning portion 56a at the cleaning operation performed first to be attached to the liquid discharging faces 22a, 22a, . . . during the next cleaning operations, whereby excellent cleaning on and after the next time can be performed.

In addition, the cleaner unit 500 is provided with the first arm 53 and the second arm 54, which are turned in conjunction with each other, and the biasing spring 51g which biases the first arm 53 in a direction in which the cleaner 56 approaches the liquid discharging faces 22a, 22a, . . . , so that the first arm 53 and the second arm 54 are turned in necessary directions.

Therefore, it is possible to reliably perform the movement of the cleaner 56 by a simple mechanism.

In the above, the line head type liquid discharging apparatus has been described as an example of the liquid discharging apparatus 1. However, the present disclosure is not limited to the line head type liquid discharging apparatus, and provided that it has a configuration in which the platen can move in a direction away from or toward the liquid discharging faces, it is also possible to apply the present disclosure to the serial head type liquid discharging apparatus which performs recording by moving the liquid discharging head in the width direction of the recording sheet 1000.

All the specific forms and the structures of each section described in the above-described best mode are merely to illustrate one example of an embodiment when carrying out the present disclosure, and the technical scope of the present disclosure should not be interpreted as being limited by these.

The present disclosure contains subject matter related to that disclosed in Japanese Priority Patent Application JP 2010-210150 filed in the Japan Patent Office on Sep. 17, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid discharging apparatus comprising:
a liquid discharging head in which a plurality of liquid discharging nozzles that discharges liquid onto a recording sheet on the basis of image information is arranged and which has liquid discharging faces in which each nozzle orifice of the plurality of liquid discharging nozzles is arranged;
a cleaner unit having a cleaner that is made to be able to be moved in a direction in which the cleaner is separated from or brought into contact with the liquid discharging faces and that comes into contact with the liquid discharging faces, thereby cleaning the liquid discharging faces;
a platen that is disposed to face the liquid discharging faces of the liquid discharging head and retains the recording sheet in a state where the recording sheet faces the liquid discharging faces;
a unit driving mechanism that moves the cleaner unit along the liquid discharging faces; and
a platen driving mechanism that moves the platen in a direction away from or toward the liquid discharging faces,
wherein a movement pathway of the cleaner unit at the time of cleaning is formed between the liquid discharging head and the platen by moving the platen in a direction away from the liquid discharging faces by the platen driving mechanism, and
when the cleaner unit has been located between the liquid discharging head and the platen, the cleaner is made to be separated from or brought into contact with the liquid discharging faces by movement of the platen by the platen driving mechanism.

2. The liquid discharging apparatus according to claim 1, wherein the cleaner unit is moved back and forth in the movement pathway by the unit driving mechanism, and
the cleaner is separated from the liquid discharging faces in one of the forward path and the backward path of the movement pathway and comes into contact with the liquid discharging faces in the other of the forward path and the backward path of the movement pathway, thereby performing cleaning.

3. The liquid discharging apparatus according to claim 2, wherein a capping section which opens and closes the liquid discharging faces of the liquid discharging head is provided,
the cleaner is separated from the liquid discharging faces in the forward path of the movement pathway and comes into contact with the liquid discharging faces in the backward path of the movement pathway, thereby performing cleaning, and
the liquid discharging faces are blocked by the capping section in a state where cleaning by the cleaner on the liquid discharging faces has been performed.

4. The liquid discharging apparatus according to claim 1, wherein the cleaner unit includes a support base, a first arm which is supported on the support base so as to be able to turn and retains the cleaner, a second arm which is supported on the support base so as to be able to turn, and a biasing spring which biases the first arm in a turning direction in which the cleaner approaches the liquid discharging faces,
the first arm and the second arm are made to be able to turn in the same direction with respect to the support base,
the first arm is provided with an interlocking lever which is located on the opposite side to the cleaner across a turning fulcrum,
the second arm is provided with an actuating lever which acts on the interlocking lever and a pushed portion which is located on the opposite side to the actuating lever across a turning fulcrum and pushed against the platen, and
when the platen is moved in a direction in which the platen approaches the liquid discharging faces, the pushed portion is pushed by the platen, so that the second arm is turned and the first arm is turned in a direction of separating the cleaner from the liquid discharging faces, against the biasing force of the biasing spring by action of the actuating lever on the interlocking lever, and
when the platen is moved in a direction in which the platen is separated from the liquid discharging faces, pushing against the pushed portion by the platen is released, so that the second arm is turned and the first arm is turned in a direction of making the cleaner approach the liquid discharging faces, by the biasing force of the biasing spring.

5. The liquid discharging apparatus according to claim 4, wherein a roller which is rotatable in the same direction as the turning direction of the second arm is used as the pushed portion of the second arm.

6. The liquid discharging apparatus according to claim 4, wherein the cleaner unit is moved back and forth in the movement pathway by the unit driving mechanism,
the cleaner is separated from the liquid discharging faces in one of the forward path and the backward path of the movement pathway and comes into contact with the liquid discharging faces in the other of the forward path and the backward path of the movement pathway, thereby performing cleaning, and
the cleaner is pressed against the liquid discharging faces by the biasing force of the biasing spring in the other of the forward path and the backward path of the movement pathway.

7. The liquid discharging apparatus according to claim 1, wherein the cleaner is rotatable only in one direction,
a cleaner separation and contact mechanism which moves the cleaner in a direction in which the cleaner is separated from or brought into contact with the liquid discharging faces is provided,
a rotation control mechanism which makes the cleaner be able to rotate in a first direction and be unable to rotate in a second direction opposite to the first direction is provided,
a head frame that has guide portions with which the cleaner can come into contact and which are provided at an end portion in a movement direction of the cleaner unit and that covers and retains the liquid discharging head from the outer circumferential side is provided, and
the cleaner is made to be rotated in the first direction when the cleaner has come into contact with the guide portions at the time of movement of the cleaner unit.

8. The liquid discharging apparatus according to claim 7, wherein the cleaner unit is moved back and forth in the movement pathway by the unit driving mechanism,
the cleaner is separated from the liquid discharging faces by the cleaner separation and contact mechanism at the time of movement in one of the forward path and the backward path of the cleaner unit, and
the cleaner comes into contact with the liquid discharging faces in a non-rotatable state by the rotation control mechanism at the time of movement in the other of the forward path and the backward path of the cleaner unit, thereby performing cleaning.

9. The liquid discharging apparatus according to claim 7, wherein the cleaner is provided with a ratchet gear, and
a ratchet mechanism which includes the ratchet gear and a ratchet claw that is engaged with a gear tooth of the ratchet gear is used as the rotation control mechanism.

10. The liquid discharging apparatus according to claim 9, wherein the number of gear teeth of the ratchet gear is set to be a prime number.
